(19) United States
(12) Patent Application Publication
(10) Pub. No.: US 2010/0200330 A1
(43) Pub. Date: Aug. 12, 2010

(54) TRUSS GUSSET PLATE AND ANCHOR SAFETY SYSTEM

(76) Inventor: Lawrence A. Crookston, Barberton, OH (US)

Correspondence Address: SAND & SEBOLT, AEGIS TOWER, SUITE 1100, 4940 MUNSON STREET, NW, CANTON, OH, 44718-3615, US

(21) Appl. No.: 12/766,568

(22) Filed: Apr. 23, 2010

Related U.S. Application Data
(63) Continuation-in-part of application No. 12/504,305, filed on Jul. 16, 2009.
Application No. 12/504,305 is a continuation-in-part of application No. 12/100,122, filed on Apr. 9, 2008.
Application No. 12/100,122 is a continuation-in-part of application No. 11/069,819, filed on Mar. 1, 2005, now Pat. No. 7,380,373.

(51) Int. Cl. A62B 35/00; E04B 1/21; E04H 12/00

(52) U.S. Cl. 182/3; 52/712; 52/655.1

(57) ABSTRACT

A gusset plate for securing roof truss members together and aiding in anchoring a security line. The plate is planar and metallic having front and rear surfaces and an outer perimeter. Teeth project outwardly from the rear surface. The perimeter includes a flat or V-shaped first edge and a U-shaped second edge. The V-shape and U-shape open in the same direction. The plate includes first and second wings defined between the first and second edges and extending for a distance along the front surfaces of the truss members. A shackle on the security line is secured to the roof truss proximate where the roof truss is reinforced by the gusset plate. The plate secures the truss members together and can provide a strong, rigid surface for the shackle to engage thereby reducing the likelihood of damage to the truss when force is applied to the security line.

### CROSS-REFERENCE TO RELATED APPLICATIONS

This is a Continuation-in-Part of U.S. patent application Ser. No. 12/504,305, filed Jul. 16, 2009, which is a Continuation-in-Part of U.S. patent application Ser. No. 12/100,122, filed Apr. 9, 2008, which is a Continuation-in-Part of U.S. patent application Ser. No. 11/069,819, filed Mar. 1, 2005, now U.S. Pat. No. 7,380,373, the entire disclosures of all of which are incorporated herein by reference.

### TECHNICAL FIELD

This invention relates to a roof truss connector plate and roof anchor safety system and, in particular, to a connector plate having an anchor portion extending downwardly therefrom that allows components of the roof anchor system to be secured to a roof truss. The truss connector plates are factory installed when the roof truss is formed and provide certifiable anchor capacity to the user.

### BACKGROUND OF THE INVENTION

The need for securing roofing roofers on pitched roofs is well known and is now being required by many government regulations. Many safety systems have been developed to secure roofers, with the majority involving an anchor attached to either a rafter of a truss or to the surface of the roof. These prior art anchor systems may be temporary or permanent.

A problem with these prior art systems is that they rely on a roofing roofer to initially attach the anchor. This often can result in the anchor being attached incorrectly. The potential misconnection of anchor bolts, screws and brackets, and the resulting personal injury, is a serious problem with the prior art safety systems. Additionally, due to the potential liability, building contractors many times retain independent sub-contractors that are expected to provide proper protection, but many times fail to do so. The difficulty and potential for improper installation lead to disastrous results if a roof roofer should fall, and the need therefore exists for a simple, integrated approach to provide roof safety to every construction site.

Accordingly, there is a need for providing a roof anchor system that overcomes problems associated with the prior art.

### SUMMARY OF THE INVENTION

The present invention comprises a gusset plate for securing roof truss members together and aiding in anchoring a security line. The plate is planar and metallic having front and rear surfaces and an outer perimeter. Teeth project outwardly from the rear surface. The perimeter includes a V-shaped first edge and a U-shaped second edge. The V-shape and U-shape open in the same direction. The plate includes first and second wings defined between the first and second edges and extending for a distance along the front surfaces of the truss members. A crossbar of a shackle on the security line contacts the first edge of the plate and a shackle pin contacts the second edge. The plate secures the truss members together and provides a strong, rigid surface for the shackle to engage thereby reducing the likelihood of damage to the truss when force is applied to the security line.

### BRIEF DESCRIPTION OF THE DRAWINGS

This invention will now be described in further detail with reference to the accompanying drawings, in which:

FIG. 1A is a front view of a peak gusset of a roof anchor system of the present invention and FIG. 1B is a detail perspective view of one of the plurality of teeth of the peak gusset of FIG. 1A;

FIG. 2 is a side view of a pair of peak gussets, as shown in FIG. 1, attached to a truss rafter;

FIG. 3 is a perspective view of a truss formed with the peak gussets of FIG. 1 and shown with a building structure generally shown in phantom;

FIG. 4 is a perspective view of a high reach accessory of the roof anchor system of the present invention;

FIG. 5 is a perspective view of a roof having the roof anchor system of the present invention attached thereto;

FIG. 6 is a perspective view of a support ferrule insert of the roof anchor system of the present invention;

FIG. 7 is a front view of a second embodiment of the peak gusset of the present invention shown in a single piece configuration;

FIG. 8 is a side view of the double gusset of FIG. 7 shown attached to a truss rafter;

FIG. 9 is a partial perspective view of a truss formed with the double peak gusset of FIG. 7 and a support ferrule of FIG. 6 shown exploded therefrom;

FIG. 10 is a front view of another embodiment of the peak gusset of the present invention shown in a single piece configuration;

FIG. 11 is a side view of the double gusset of FIG. 10 shown attached to a truss rafter;

FIG. 12 is a partial perspective view of a truss formed with the double peak gusset of FIG. 10 and a support ferrule of FIG. 6 shown exploded therefrom;

FIG. 13 is a perspective view of another embodiment of the high reach accessory of the roof anchor system of the present invention;

FIG. 14 is a perspective view of a high reach accessory of FIG. 13 shown attached over a portion of a truss using the peak gusset of the present invention;

FIG. 15 is a partial perspective view of another embodiment of the peak gusset having fold over side reinforcements, shown attached to a plurality of truss rafters and truss webs;

FIG. 16 is a partial perspective view of another embodiment of the peak gusset having a low profile attachment extension, shown attached to a plurality of truss rafters and truss webs;

FIG. 17 is a partial perspective view of the peak gusset as shown in FIG. 16 having a plurality of D rings attached thereto as a cable harness hook up;

FIG. 18 is a front view of a low anchor profile embodiment of the peak gusset of the present invention shown in a single piece configuration;

FIG. 19 is a side view of the peak gusset of FIG. 18, shown attached to a truss rafter;

FIG. 20 is a partial perspective view of a truss formed with the peak gusset of FIG. 18 shown with a metal loop;

FIG. 21 is a partial perspective view of a truss formed with the peak gusset of FIG. 18 shown with a side clip;

FIG. 22 is a front view of a second low anchor profile embodiment of the peak gusset of the present invention shown in a single piece configuration;

FIG. 23 is a side view of peak gusset of FIG. 22, shown attached to a truss rafter;

FIG. 24 is a partial perspective view of a truss formed with the peak gusset of FIG. 22;

FIG. 25 is a front view of another embodiment of the peak gusset of the present invention;

FIG. 26 is a side view of the peak gusset of FIG. 25, shown attached to a truss rafter with an unattached slide-on eyebolt base and eyebolt;

FIG. 27 is a side view of the peak gusset of FIG. 25, shown attached to a truss rafter with a slide-on eyebolt base and eyebolt attached to the peak gusset;

FIG. 28 is a partial perspective view of a truss formed with the peak gusset of FIG. 27 shown with a plurality of support members shown exploded therefrom;

FIG. 29 is a front view of another embodiment of the peak gusset of the present invention similar to the embodiment of FIG. 25;

FIG. 30 is a side view of the peak gusset of FIG. 29, shown attached to a truss rafter with an eyebolt attached to the peak gusset;

FIG. 31 is a partial perspective view of a truss formed with the peak gusset of FIG. 30 shown with a plurality of support members shown exploded therefrom;

FIG. 32 is a front view of another embodiment of the peak gusset of the present invention utilizing gusset plates with a double fold;

FIG. 33 is a side view of the peak gusset of FIG. 32, shown attached to a truss rafter;

FIG. 34 is a partial perspective view of a truss formed with the peak gusset of FIG. 32 shown with a plurality of support members shown exploded therefrom;

FIG. 35 is a front view of another embodiment of the peak gusset of the present invention, which is a one-piece version of the gusset plate of FIG. 32;

FIG. 36 is a side view of the peak gusset of FIG. 35, shown attached to a truss rafter;

FIG. 37 is a front view of another embodiment of the peak gusset of the roof anchor system of the present invention shown attached to a truss with the peak of the truss shown in phantom and sheet material secured to the truss;

FIG. 38a is a front view of the peak gusset of FIG. 37 with a carabiner and rope secured through a first one of the holes in the gusset;

FIG. 38b is a front view of the peak gusset of FIG. 37 with the carabiner and rope secured through the second one of the holes in the gusset;

FIG. 39 is a top view of the peak gusset of FIG. 38 with the carabiner resting on the uppermost edge of the sheet material;

FIG. 40 is a side view of the peak gusset of FIG. 38 showing the top flap folded over;

FIG. 41 is a front view of the peak gusset in accordance with the present invention secured to a truss and covered by a ventilation cap;

FIG. 42 is a top view of a pair of peak gussets secured on either side of a truss with sheet members extending outwardly away therefrom;

FIG. 43 is a side view of the pair of peak gussets of FIG. 42;

FIG. 44 is front view of the pair of peak gussets of FIG. 42 and showing an anchor system connected thereto;

FIG. 45 is a top view of the pair of peak gussets of FIG. 44 showing the anchor system secured thereto;

FIG. 46 is a side view of the pair of peak gussets and the anchor system of FIG. 45;

FIG. 47 is a top view of a pair of spaced apart trusses to which peak gussets in accordance with the present invention are secured and showing a cable type of connector member connecting the spaced apart peak gussets and an anchoring system secured thereto; and

FIG. 48 is a top view of a pair of spaced apart trusses to which peak gussets in accordance with the present invention are secured and showing a rod type of connector member connecting the spaced apart peak gussets and an anchoring system secured thereto;

FIG. 49a is a front view of yet another embodiment of a gusset plate in accordance with the present invention;

FIG. 49b is a side view of the plate of FIG. 49a;

FIG. 50 is a front view of the plate shown attached to a truss and showing sheet material secured to one of the truss members;

FIG. 51 is a front view of the plate with a shackle engaged therewith and connecting a carabiner and security line thereto;

FIG. 52 is a left side view of the truss showing a pair of plates attached to opposing side surfaces of the truss members;

FIG. 53 is a front view of yet another embodiment of the gusset plate in accordance with the present invention;

FIG. 53A is a front view of the gusset plate shown in FIG. 53 showing a flat top and optional structure in phantom;

FIG. 54 is a cross-sectional side view of the gusset plate shown in FIG. 53; and

FIG. 55 is a front view of the embodiment of FIG. 53 shown secured to members of a truss and having a carabiner and security line engaged therewith.

### DETAILED DESCRIPTION OF THE INVENTION

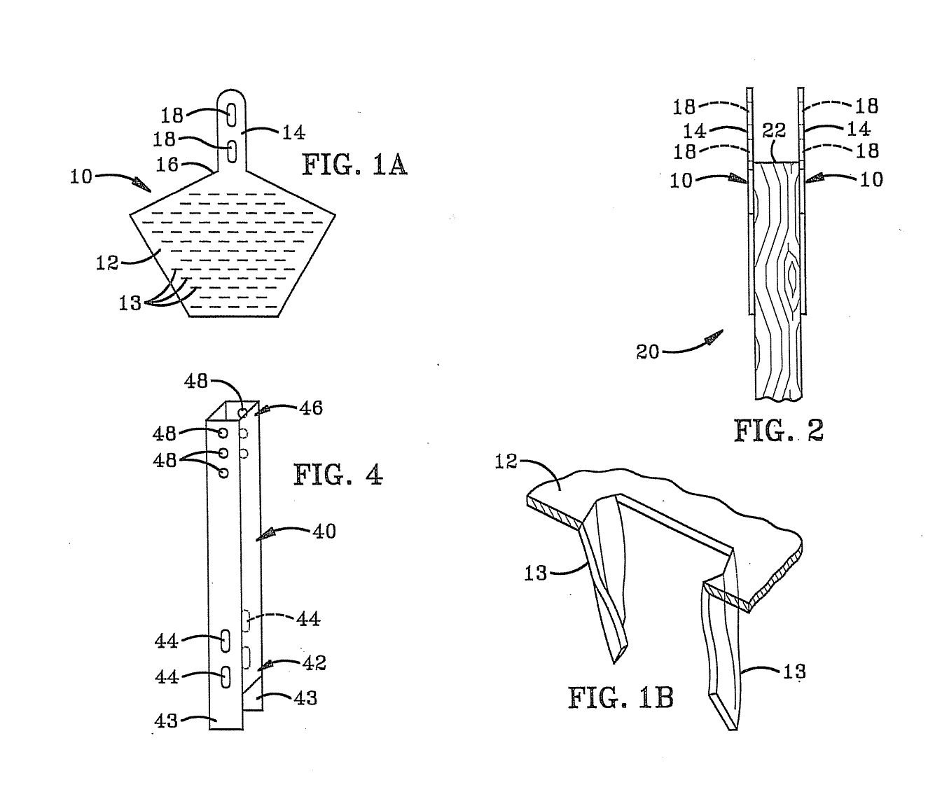

The present invention is directed to an integrated roof safety system wherein successful attachment of this device is assured because it is designed to be installed under ideal and regulated factory conditions. The provision of this device, by the general building contractor, for use by the various hired subsequent subtrades, will create a safe workplace and cause more compliance with existing government regulations. The result will be practical, economical and failsafe product and system. The roof anchor safety system 110 of the present invention will now be described in detail with reference to various embodiments thereof. Referring now to FIG. 1A, a truss connector plate 10 for use at the peak of a truss and referred to herein as a peak gusset 10 is shown and comprises the primary component of the roof anchor safety system 110. The peak gusset 10 comprises a plate 12 of steel having a plurality of teeth 13 formed from the plate 12 and extending perpendicularly from the plate 12 as best shown in FIG. 1B. Referring back to FIG. 1A, the exact shape of the plate being unimportant, it is only necessary that the plate be of sufficient size and geometry to resist anticipated pull forces. The peak gusset 10 further comprises an anchor portion 14 extending from the peak side 16 of the gusset 10. The peak gusset 10 is monolithic such that the anchor portion 14 is an extension of the plate 12. The anchor portion 14 includes a means for attachment 18 of other safety items, the attachment means shown herein as a pair of apertures 18 in the form of a slot 18. It is noted that other attachment means are contemplate such as an open slot for engaging a stud of the type used for bayonet connection, or other known connection devices. The thickness of the gusset 10 may be of a standard gusset thickness, typically 16-20 gauge, or may be made of a thicker gauge for added strength.

A peak gusset 10 is attached to either side of a truss peak 22 as shown in FIG. 2. The plurality of teeth (not shown) is pressed into the wooden truss peak 22 during manufacture of the truss 20 typically using a roll or hydraulic press. Manufacture of the truss is accomplished at the factory under standard environmental conditions to control the quality and strength of the truss. The anchor portion 14 extends outward from the truss peak 22. At lease one aperture 18 provides a connection location for other elements of the roof anchor safety system 110. Although not shown, it is contemplated that the anchor portion 14 can be formed with vertically extending ribs in a pressed single or multiple wave or corrugated type configuration to add additional strength to the anchor portion 14 of the gusset 10. Between the manufacture and installation f the truss 20, the anchor portion 14 may be covered with a protective coating or covering (not shown) such as foam wrap or the like in order to protect the anchor portion 14 as well as roofer handing the truss 20. A wooden piece of strap material may also be inserted between the anchor portions 14 and temporarily secured to provide additional protection against bending or other damage to the anchor portions 14 during handling and transportation.

The resulting truss 20 is shown in FIG. 3 with the peak gusset 10 positioned such that the anchor portion 14 of the gusset 10 extends upward from a ridge line 30 formed by the other truss peaks 32 of the roof 34 (shown in phantom). The anchor portion 14 provides an attachment location for D-rings, hooks, cables, and other means of securing a person while working on the roof 34. It is important to note that, although the peak gusset 10 is shown in the present disclosure solely at the peak of a truss 20, it is contemplate that the other truss connection plates 36 could be configured with an anchor portion as well.

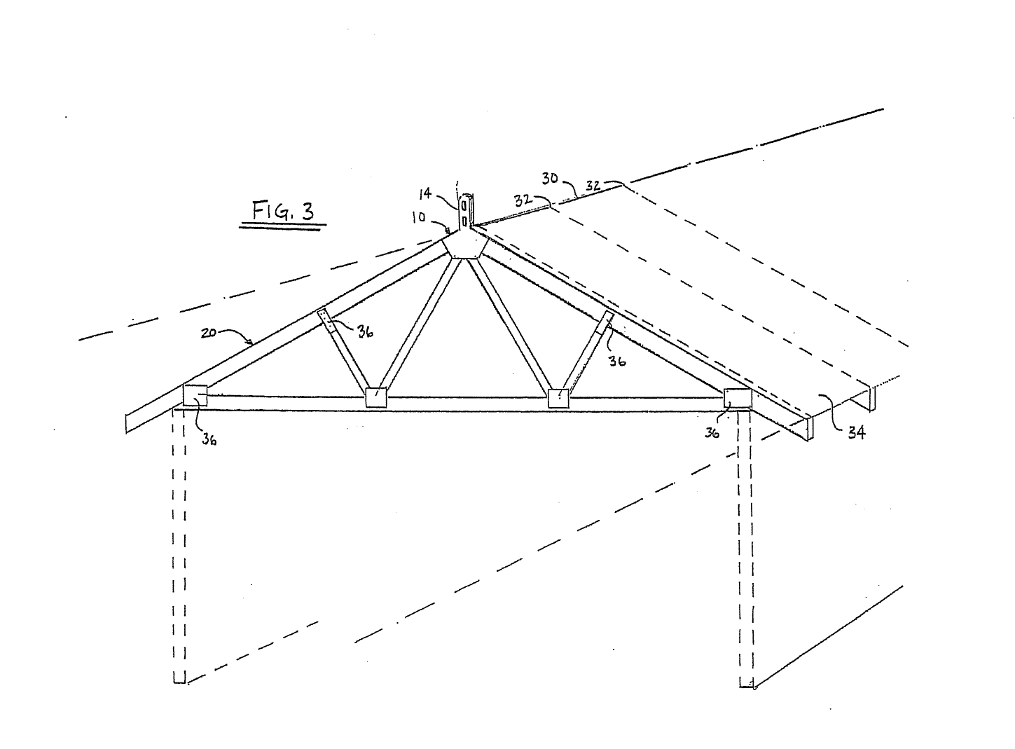

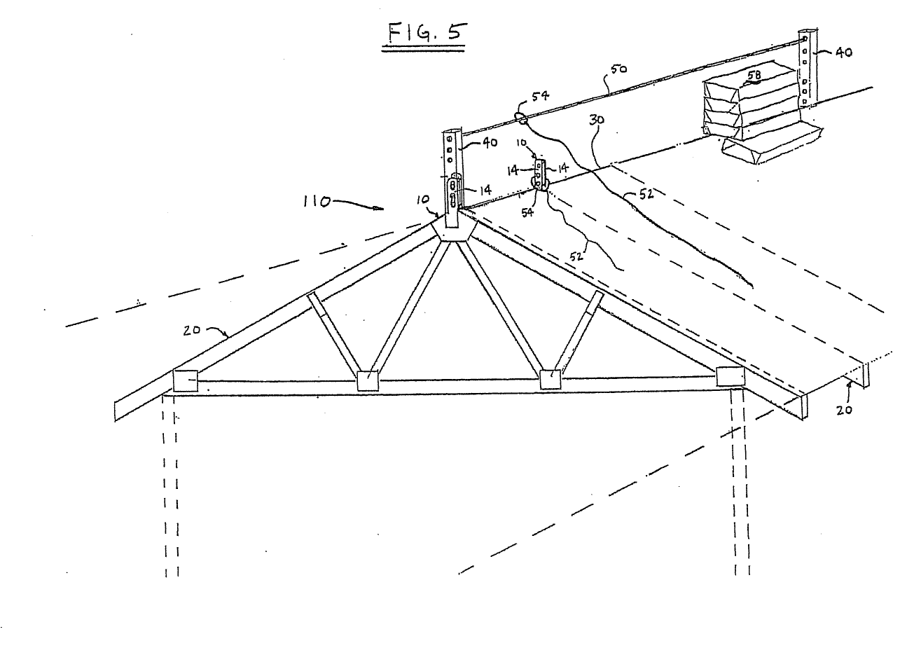

The roof anchor system 110 of the present invention further comprises an anchor extension member 40 referred to as a high reach accessory 40 as shown in FIG. 4. The high reach accessory 40 is essentially an extension bar of a predetermined length that attaches at a first end 42 to the peak gusset 10. The first end 42 may also include sidewall extensions 43 that extend over the sides of the truss peak 22 to provide additional stability and prevent low-impact side-to-side collapse of the anchor portions 14 of the gussets 10. The first end 42 fits over the anchor portions 14 and includes an attachment means 44 for securing the high reach accessory 40 to the anchor portions 14 herein shown as apertures 44 in the form of slots 44. The opposite end 46 of the high reach accessory 40 includes attachment means 48 for attachment of other safety items, the attachment means 48 shown herein as a plurality of apertures 48.

The roof anchor safety system 110 of the present invention is shown in FIG. 5. A truss 20 is shown having peak gussets 10 attached thereto. A high reach accessory 40 is shown attached over the anchor portion 14 (shown as visible even though covered) of the peak gussets 10. A second high reach accessory 40 is attached to a second peak gusset (not shown) further down the ridge line 30. A tether line 40 is attached to and extends between the high reach accessories 40. A harness line 52 is shown slidably attached to the tether line 50 by an attachment ring 54. An additional truss 20 is shown having peak gussets 10 and is positioned between the two high reach accessories 40. A harness line 52 is shown attached to the anchor portions 14 of the peak gussets 10 by an attachment ring 54. Squares of shingles 58 are shown positioned along the ridge line 30.

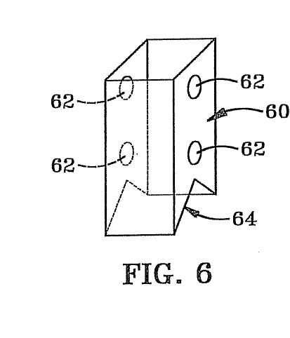

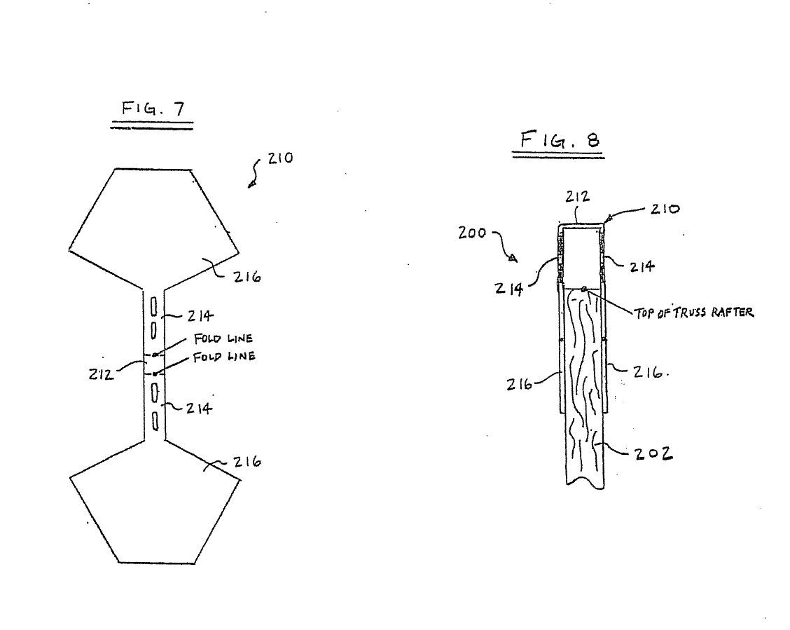

FIG. 6, a support ferrule insert is shown for insertion between the anchor portions 14 of the gussets 10 to provide additional support and strength to the anchor portions 14. The support ferrule 60 includes apertures 62. The support ferrule 60 is shown as a tubular member or it may be a solid block. The support ferrule 60 is positioned prior to attachment of the high reach accessory 40. The support ferrule 60 may also include a first end 64 that is formed at an angle to mate with or bridge the peak of the truss 20 and provides additional support to prevent front-to-back low impact collapse of the anchor portions 14 of the gussets 10.

When the roof anchor safety system 110 is no longer needed, the harnesses 52, tether lines 50, high reach accessories 40, D0rings 54 and the like, and support ferrule inserts 60, are removed from the anchor portions 14 and used again as needed. The anchor portions 14 are typically cut near the top of the truss 20 and then folded over the top of the truss 20. Alternatively, the anchor portions 14 may not need to be cut but rather just be bent over the truss and positioned below the roof. It is also contemplated that the anchor portions 14 may be covered and left in place, with or without a ferrule insert support 60 between the extensions 14.

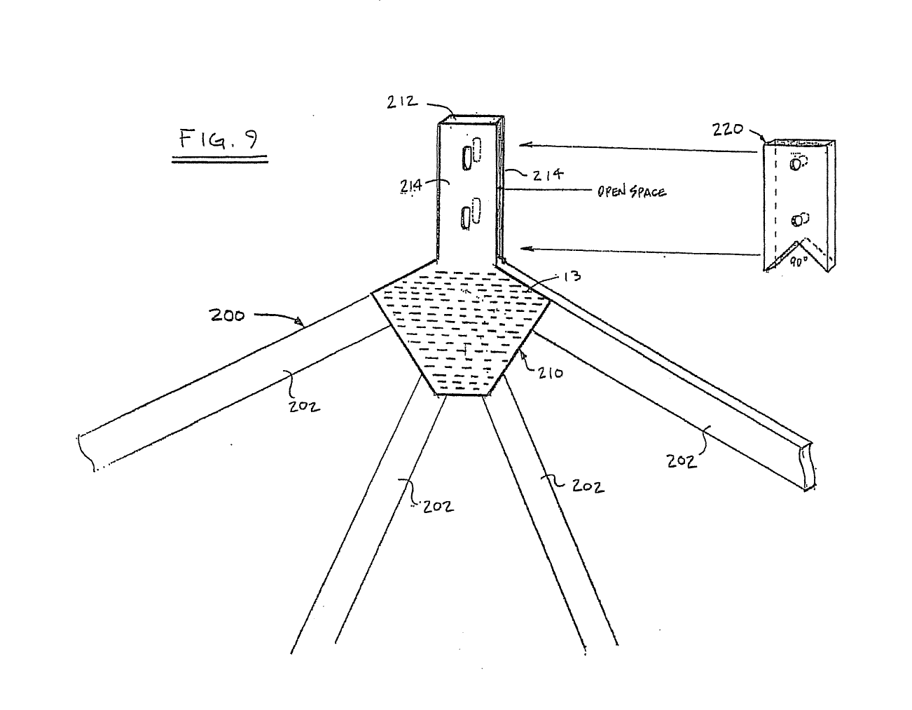

In FIGS. 7-12, two additional embodiment of the peak gusset 210,310 are shown that are manufactured as one piece and then folded prior to attachment to form the truss 200, 300. Referring now to FIG. 7, a double peak gusset 210 is shown having a connection portion 212 between the anchor portions 214 of the double gusset 210. A plurality of teeth (not shown) extends perpendicularly from each plate portion 216. The double peak gusset 210 is folded on either end of connection portion 212 and attached to form a truss 200 by the plurality o teeth (not shown) engaging the truss members 202 as shown in FIG. 8. The attached peak gusset 210 is shown in a partial perspective view in FIG. 9. The peak gusset anchor portions 214 remain connected by connection portion 212, providing enhanced strength of the anchor portions 214. A support ferrule insert 220 is shown as insertable between the anchor portions 214 and underneath the connection portion 212.

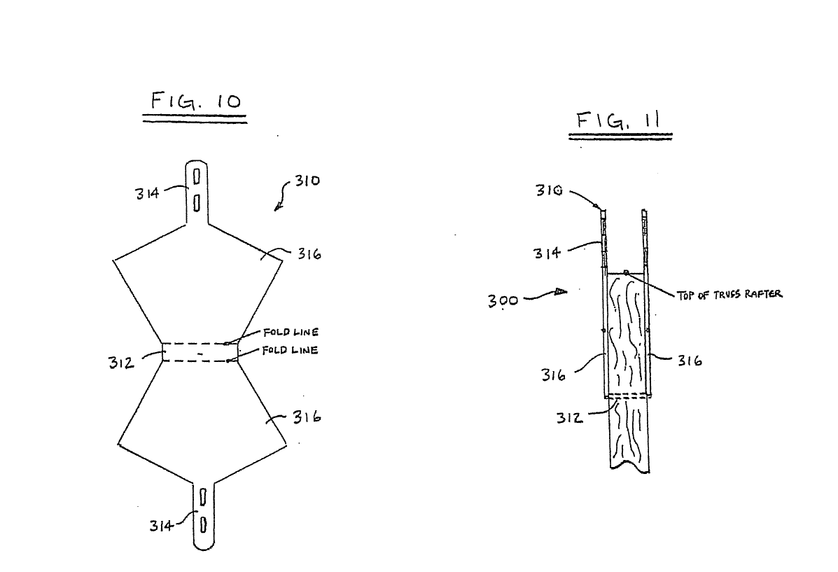

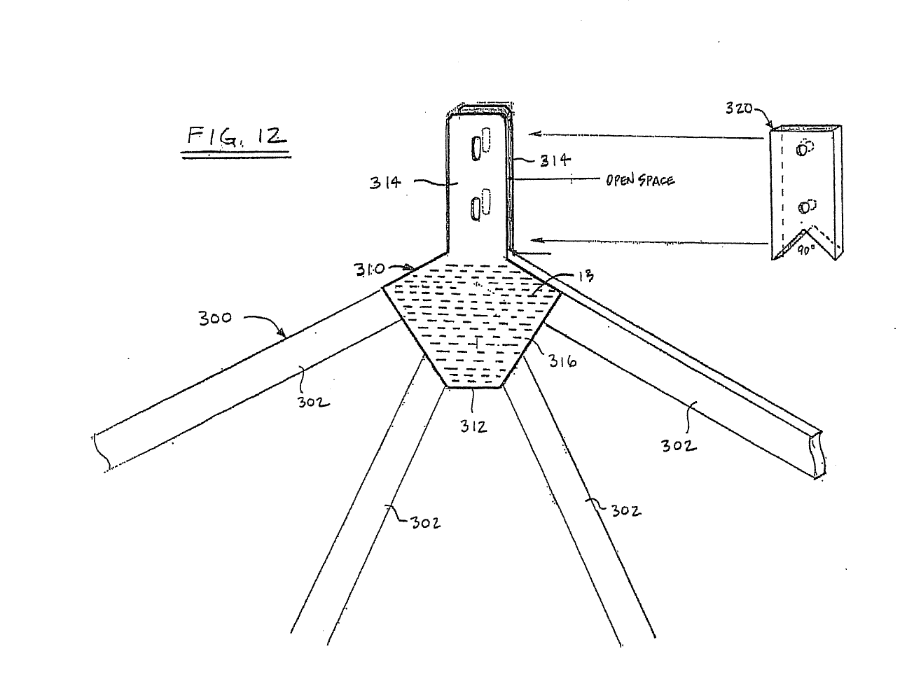

Referring now to FIG. 10, another embodiment of a double peak gusset 310 is shown having a connection portion 312 between the plate portions 316 of the double gusset 310. A plurality of teeth (not shown) extend perpendicularly from each plate portion 316.s The double peak gusset 310 is folded on either end of connection portion 312 and attached to form truss 300 by the plurality of teeth (not shown) engaging the truss members 302 as shown in FIGS. 11 and 12. The attached peak gusset 310 is shown in a partial perspective view in FIG. 12. The peak gusset plate portions 316 remain connected by connection portion 312. A support ferrule insert 320 is shown as insertable between the anchor portions 314 as shown in previous embodiments.

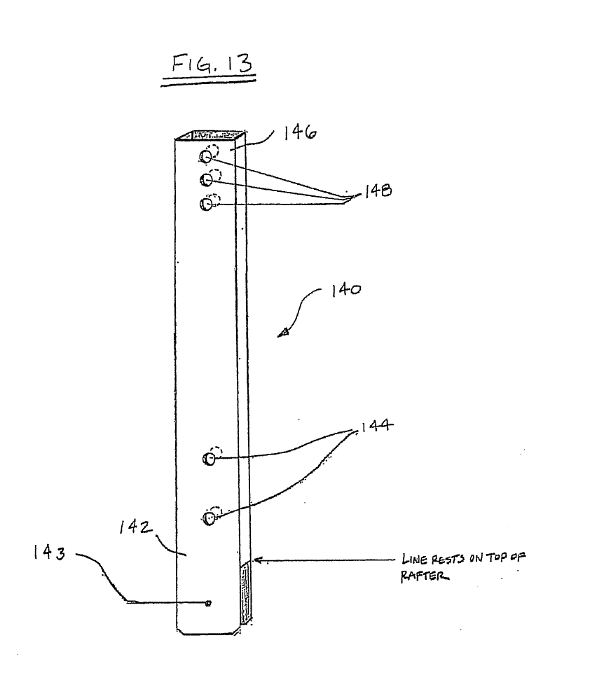

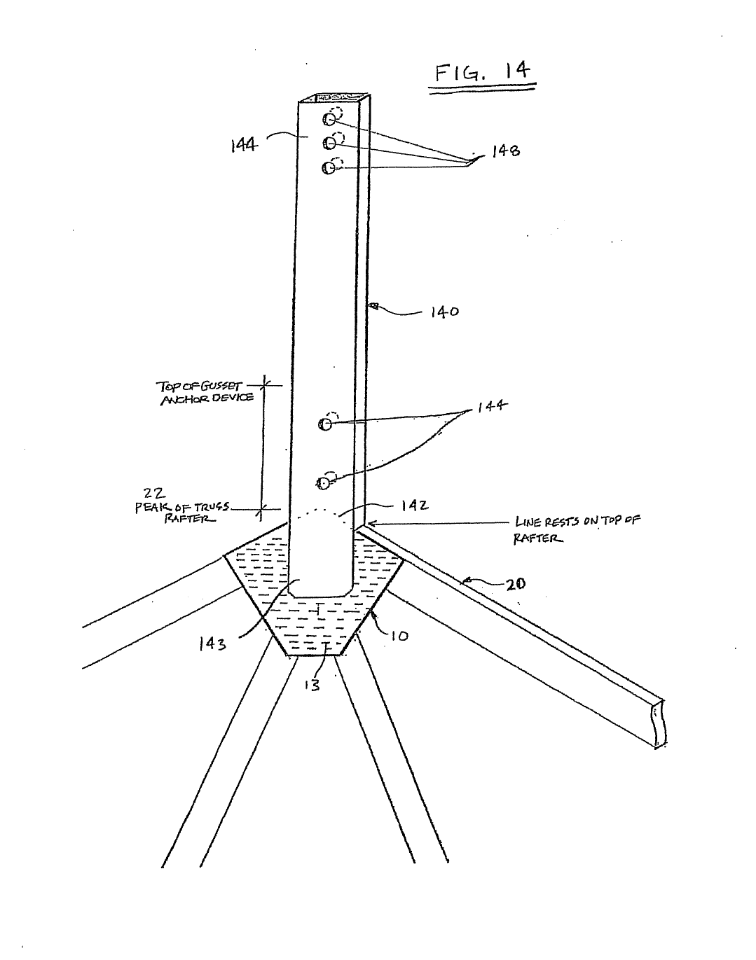

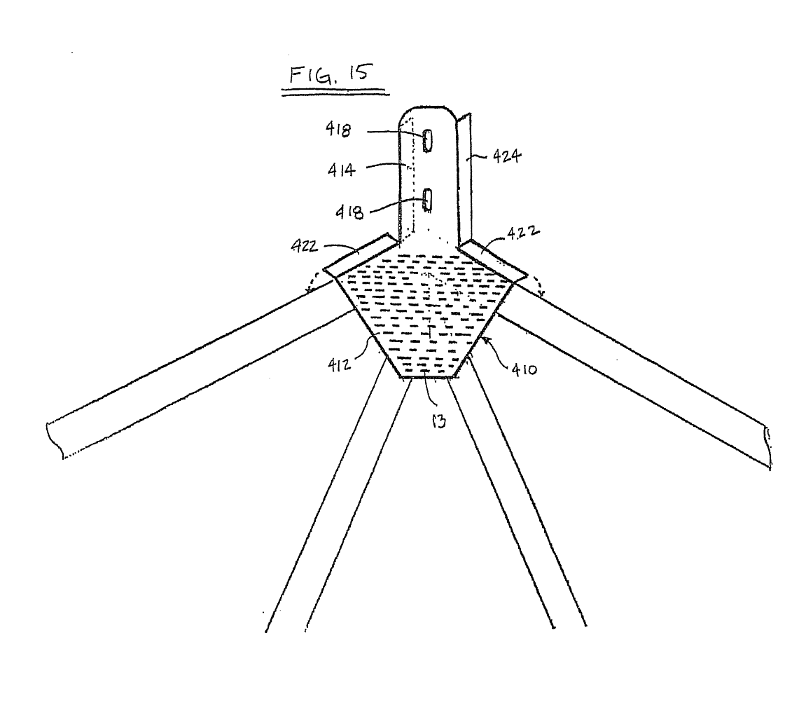

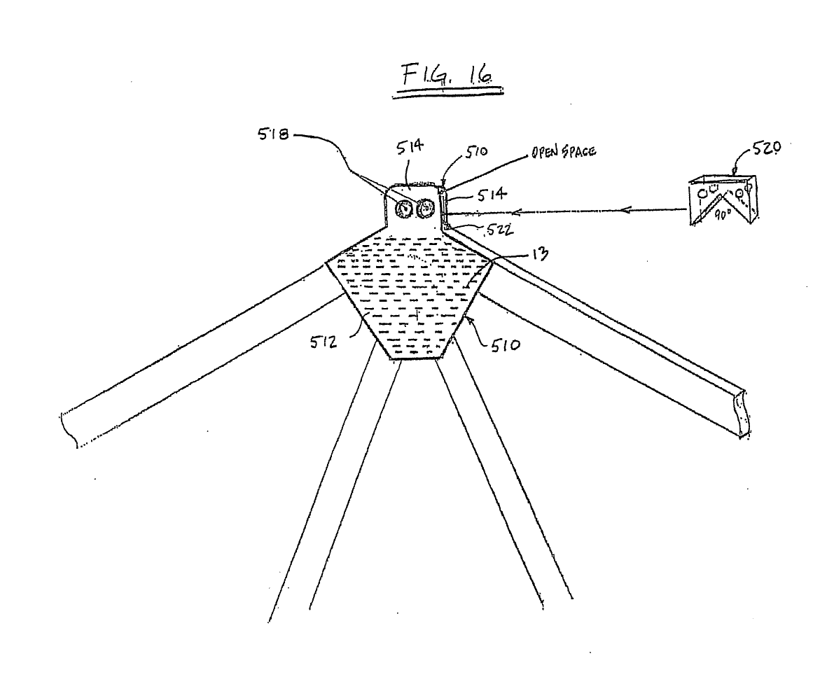

A variation of the high reach accessory 140 is shown in FIG. 13. The high reach accessory 140 is similar to the previous embodiment of the high reach accessory 40 except that it has a rectangular tubular cross-section as opposed to a square cross-section, and apertures 144 and the first end 142 are circular as opposed to slots. The invention is not limited to a particular configuration of the high reach accessory 40, 140. As with the previous embodiment, the high reach accessory 140 also may include sidewall extensions 143 that extend over the sides of the truss peak 22 to provide additional stability and prevent low-impact side-to-side collapse of the anchor portions 14 of the gussets 10 as best shown in FIG. 14. The first end 142 fits over the anchor portions 14. As with the previous embodiment, the opposite end 1456 of the high reach accessory 140 includes attachment means 148 for attachment of other safety items, the attachment means 148 shown herein as a plurality of apertures 148.

Another embodiment of the peak gusset 410 is shown in FIG. 15. The peak gusset comprises a plate 412 of steel having a plurality of teeth (not shown) formed from the plate and extending perpendicularly from the plate 412. The peak gusset 410 further comprises an anchor portion 414 extending from the peak side of the gusset 410. The anchor portion 414 includes a means for attachment 418 of other safety items, the attachment means shown herein as a pair of apertures 418. Gusset 410 includes reinforcing flaps 428 extending from the anchor portion 414 and reinforcing flaps 422 extending from the plate 412. When a peak gusset 410 is attached to either side of a truss 400, the flaps 412, 422 of each gusset are folded perpendicular to their respective gussets 410 and provide additional support for the anchor portion 414. A support ferrule insert (not shown) may still be used. If needed, and is insertable through an opening at the top of the anchor portions 414 of the gussets 410.

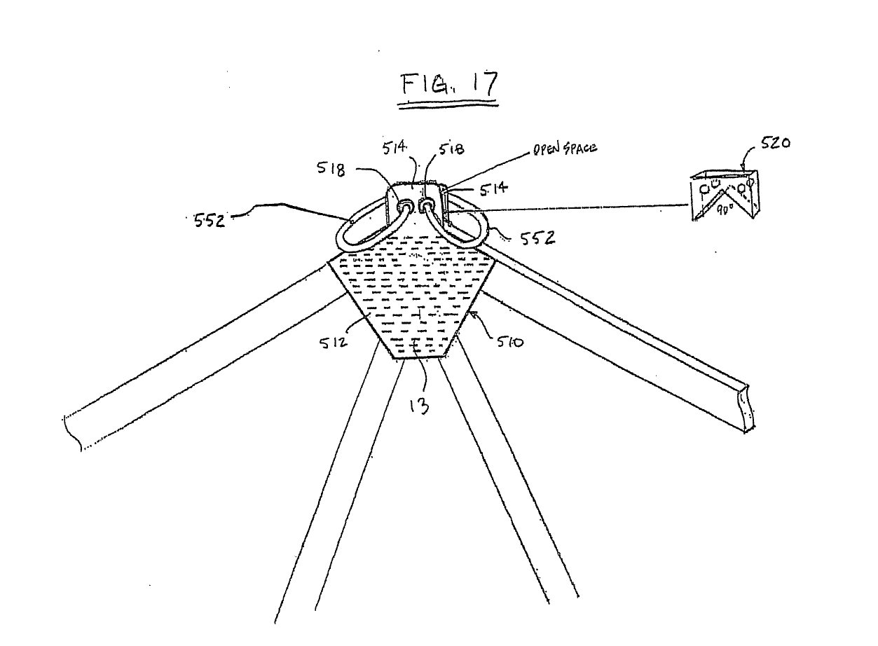

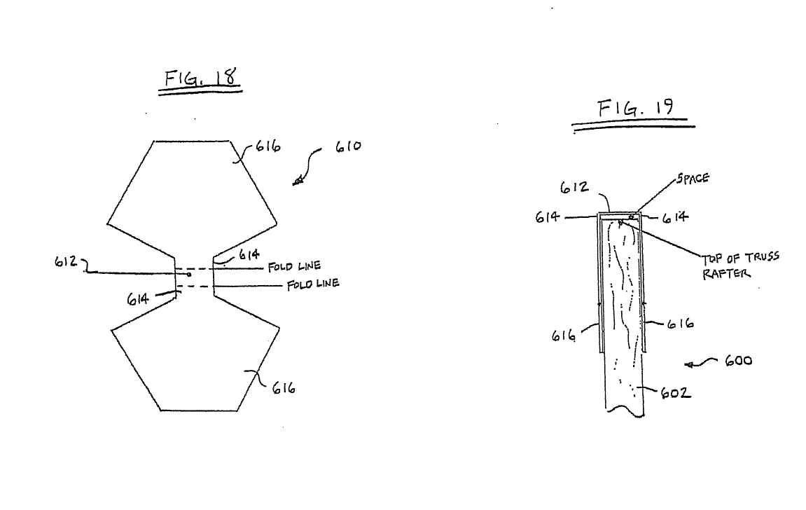

Another embodiment of the peak gusset 510 is shown in FIGS. 15 and 16. The peak gusset comprises a plate 512 of steel having a plurality of teeth (not shown) formed from this plate and extending perpendicularly from the plate 512. The peak gusset 510 further comprises an anchor portion 514 extending from the peak side of the gusset 510. The anchor portion 514 includes a means for attachment 518 of other safety items, the attachment means shown herein as a pair of apertures 518. A peak gusset 510 is attached to either side of a truss peak 522. A support ferrule 520 is shown as insertable between the anchor portions 514 as shown in previous embodiments. In FIG. 17, a pair of D-rings 552 is shown attached to the peak gussets 510.

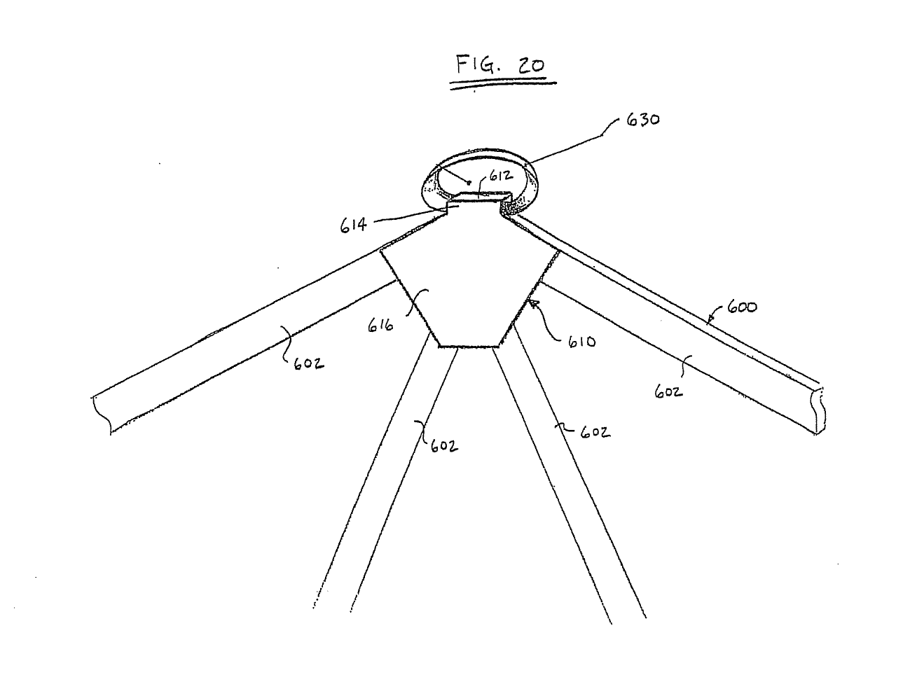

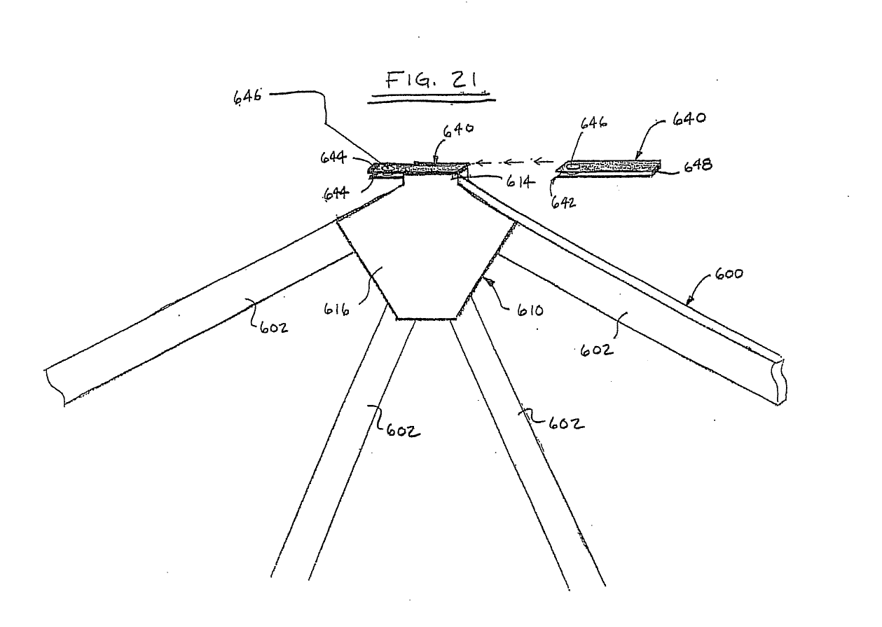

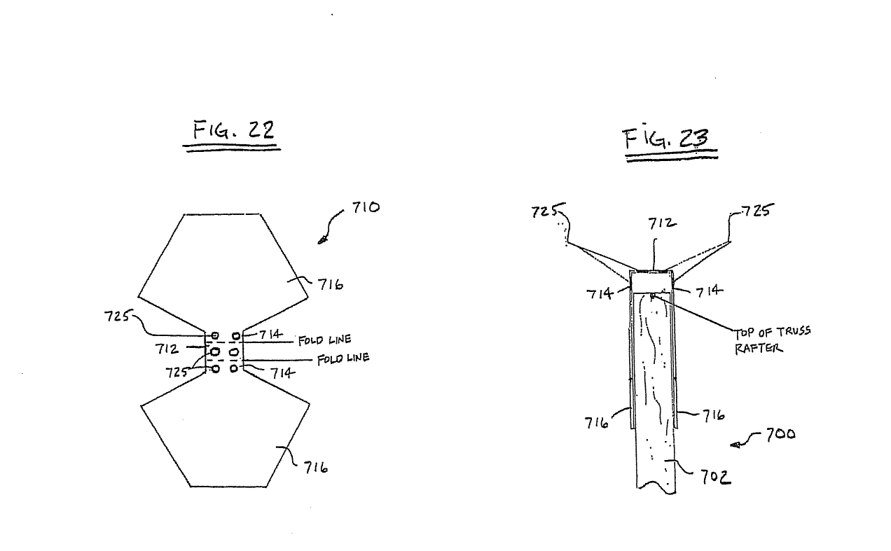

The peak gussets 10, 210, 310, 410, and 510 all have a significant extension of the anchor above the truss. The peak gusset of the present invention may also be configured in a “low profile” configuration. Referring now to FIGS. 18 and 19, a double peak gusset 610 is shown that is manufactured as one piece and then folded prior to attachment to form the truss 600. Double peak gusset 610 comprises a connection portion 512 between the anchor portions 614 of the double gusset 610. A plurality of teeth (not shown) extends perpendicularly from each plate portion 616. The double peak gusset 510 is folded on either end of connection portion 512 and attached to form a truss 600 by the plurality of teeth (not shown) engaging the truss member 512 as shown in FIG. 19 such that the connection portion 612 forms a cap over the anchor portions 614. The peak gusset anchor portions 615 only extend a short distance above the peak of the truss 600 and remain connected by connection portion 612, providing enhanced strength. The attached peak gusset 610 is shown in a partial perspective view in FIG. 20 including a metal loop 630 which provides an attachment location for a harness cable hook up (not shown). Another variation is shown in FIG. 21 where a slide clip 640 is used to provide an attachment location for a harness cable hook up (not shown). Slide clip 640 is a U-shaped metal band. Connection portion 5612 of the peak gusset 510 is positioned between the legs 544 of the open end 642 of slide clip 640. Apertures 646 in the legs 644 of clip 540 provide an attachment location for a harness cable hook up. The harness cable hook up and the closed end 648 of the slide clip 640 act to secure the slide clip to the peak gusset 510. The low profile of the anchor portions 6145 and connection portion 612 make it so that they can remain in place and simply be covered by the roof peak (not shown) or by ridge shingles. Alternatively, the anchor portions 614 and connection portion 612 can be removed or bent out of the way as in previous embodiments.

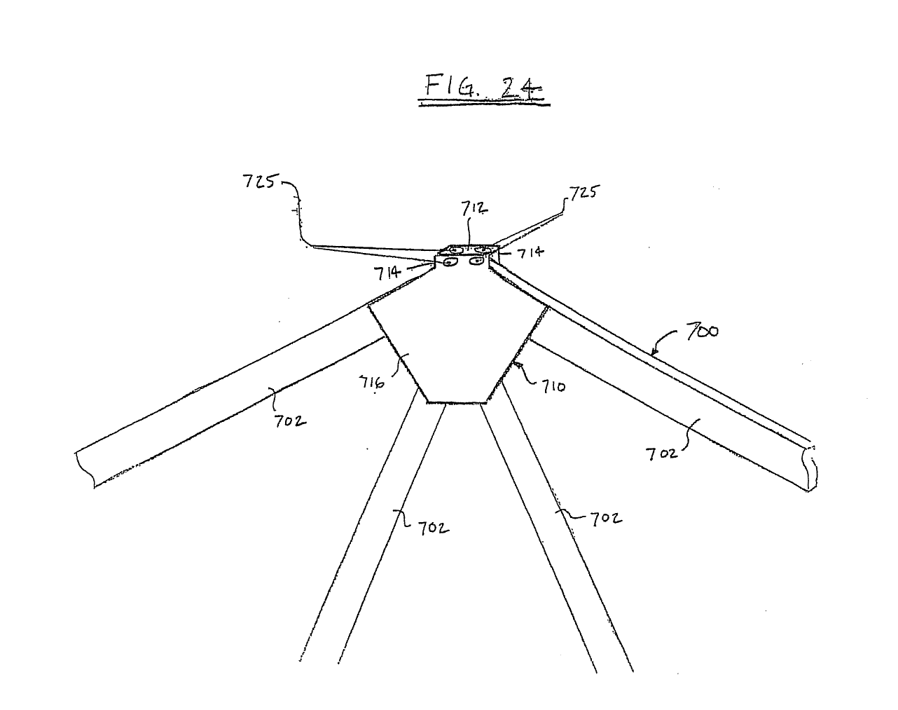

Referring now to FIGS. 22 and 23, a second embodiment of a low profile double peak gusset 710 is shown. Peak gusset 710 is manufactured as one piece and then folded prior to attachment to form truss 700. Double peak gusset 710 comprises a connection portion 712 between the anchor portions 714 of the double gusset 710. A plurality of teeth (not shown) extends perpendicularly from each plate portion 716. A plurality of apertures 725 are formed in the anchor portions 714 and/or the connection portion 712. The double peak gusset 710 is folded on either end of connection portion 712 and attached to form a truss 700 by the plurality of teeth (not shown) engaging the truss member 712 as shown in FIG. 24. Apertures 725 provide an attachment location for a harness cable hook up. As with the previous embodiment, the low profile of the anchor portions 714 and connection portion 712 make it so they can remain in place and simply be covered by the roof peak vent (not shown) or ridge shingles. Alternatively, the anchor portions 714 and connection portion 712 can be removed or bent out of the way as in previous embodiments.

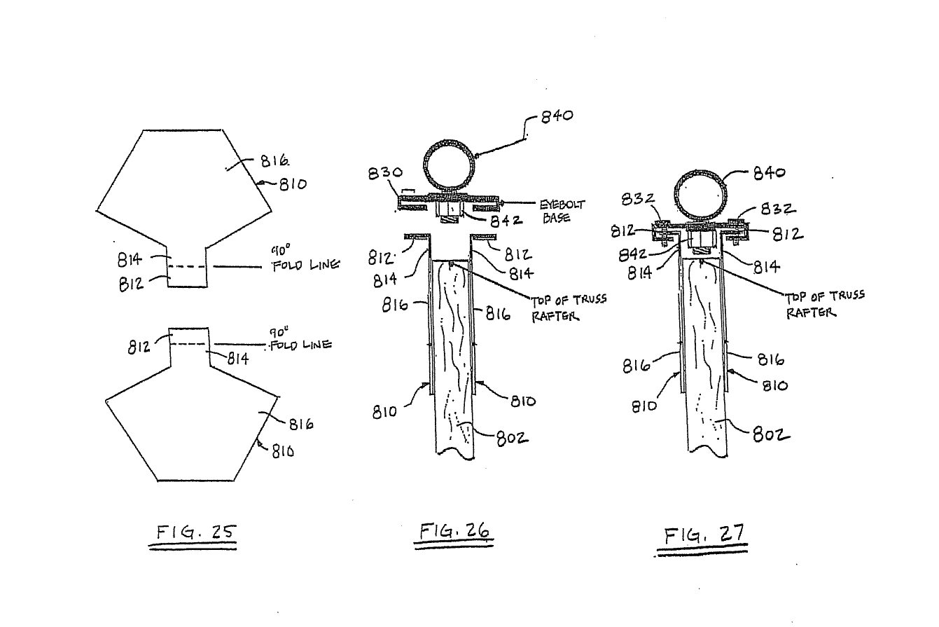

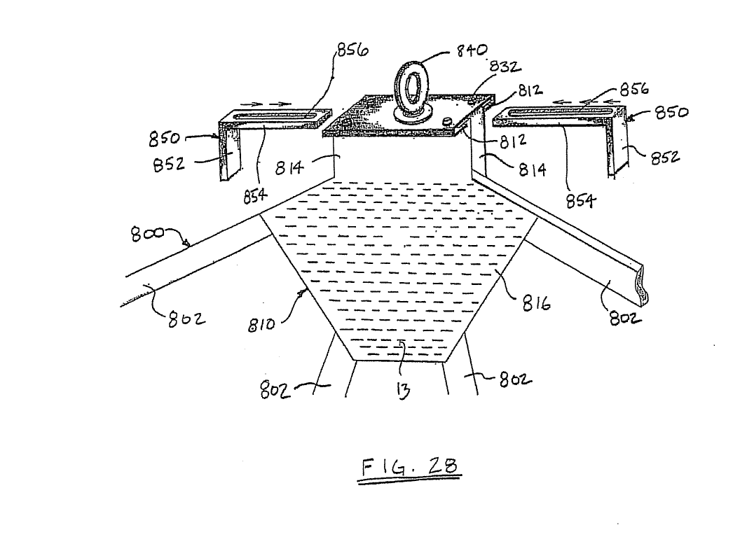

Referring now to FIGS. 25-28, another embodiment of the peak gusset 810 is shown. Peak gusset 810 comprises a plate portion 816 and an anchor portion 814 extending therefrom and having a connection portion 812. A plurality of teeth (not shown) extends perpendicularly from each plate portion 816. The gusset plates 810 are attached to form a truss 800 by the plurality of teeth (not shown) engaging the truss members 802 as shown in FIG. 26. The connection portions 812 are folded outward from the anchor portion 814 of the gusset plates 810 to form a connection flange for a slide-on eyebolt base 830 having an eyebolt 840 attached thereto by a fastener 842. The eyebolt base 830 is slid over flanges 812 and secure thereto with a plurality of fasteners 832 as shown in FIG. 27. The attached peak gusset 810 is shown I a partial perspective view in FIG. 28 attached to truss 800. In order to provide additional strength for the eyebolt connection 840, a pair of support angles 850 is provided. The support angles 850 are designed such that the legs 854 next one under the other. A slot 856 is formed in the legs 854 to allow the shaft of the eyebolt 840 to pass through. The support angles 850 are fixed in position by eyebolt 840 and fastener 842.

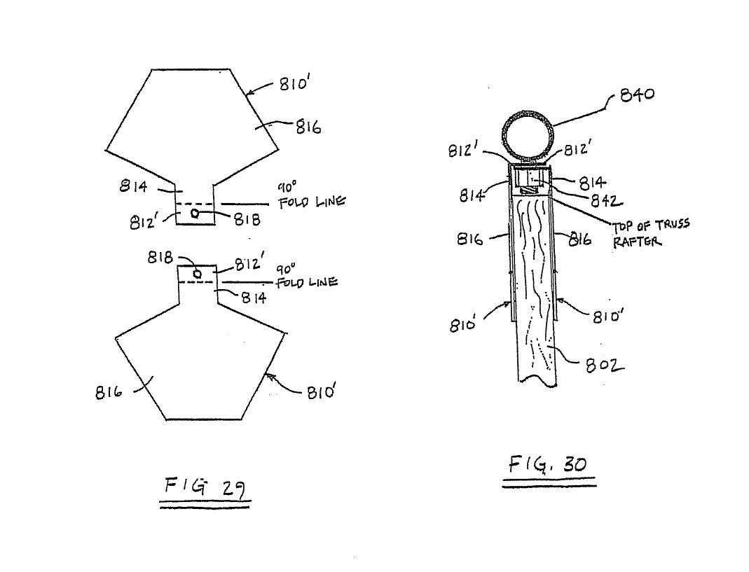

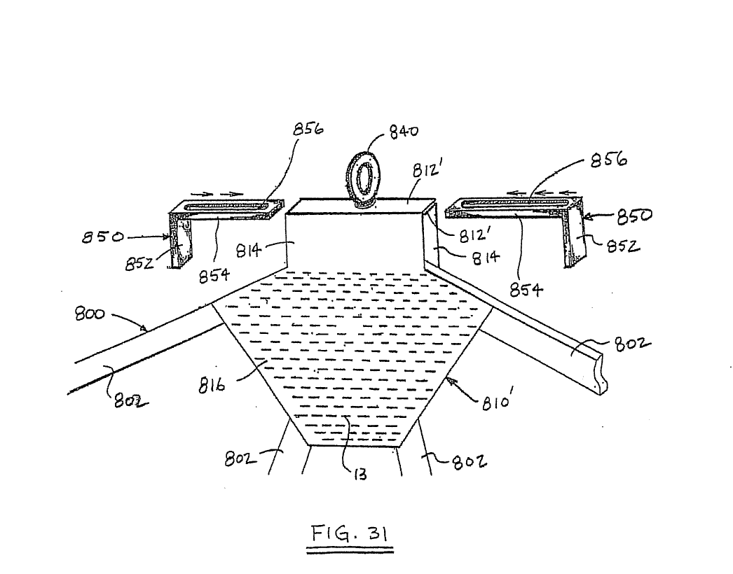

Another variation of this embodiment is shown in FIGS. 29-31. In the embodiment shown in FIG. 29 the gusset plate 810′ have an aperture 818 formed in connection portion 812′. As with the previous embodiment, the gusset plate 810′ are attached to form a truss 800 by the plurality of teeth (not shown) engaging the truss member 802 as shown in FIG. 30. However, the connection portions 812′ are folded inward from the anchor portions 814 of the gusset plate 810′ such that the apertures 818 are aligned to allow the shaft of eyebolt 840 to pass and for the eyebolt 840 to be directly attached to the connection portion 812′ by a fastener 842. The attached peak gusset 810′ is shown in a partial perspective view in FIG. 31 attached to truss 800. In order to provide additional strength for the eyebolt connection 840, the pair of support angle 850 is provided as previously discussed and shown in FIG. 28.

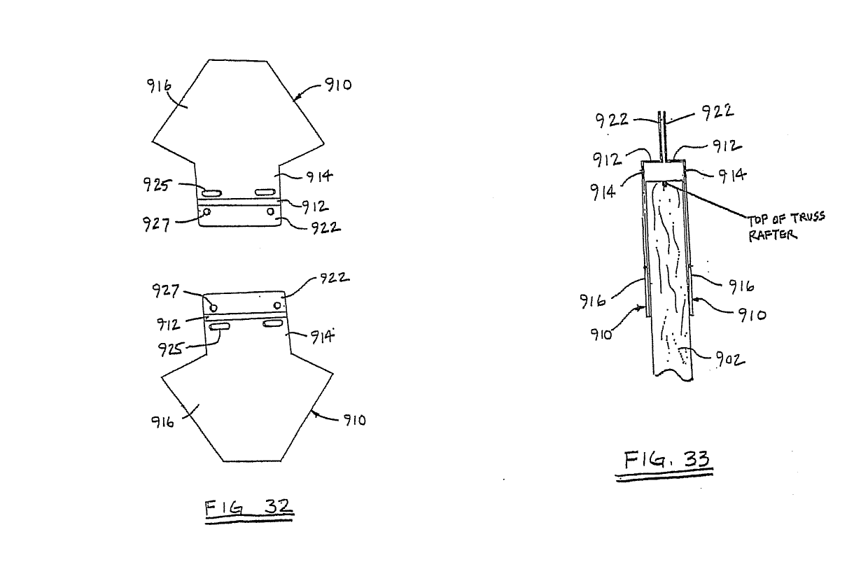

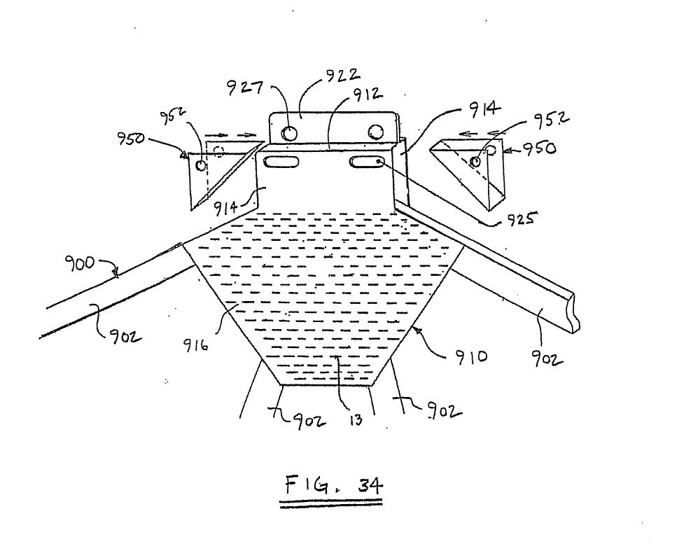

Referring now to FIGS. 32-34, another embodiment of the peak gusset 910 is shown. As shown in FIG. 32, a pair of peak gussets 910 each comprises a plate portion 916 and an anchor portion 914 extending therefrom and having a connection portion 922 having at least one aperture 927 and a shoulder portion 912 having at least one aperture 925. A plurality of teeth (not shown) extends perpendicularly from each plate portion 915. The gusset plates 910 are attached to form a truss 900 by the plurality of teeth (not shown) engaging the truss member 902 as shown in FIG. 33. The shoulder portions 912 are folded inward from the anchor portion 914 of the gusset plates 910 and connection portion 922 are folded away from anchor portion 914 such that connection portion 922 and anchor portion 914 are generally parallel to each other. The attached peak gussets 910 are shown in a partial perspective view in FIG. 34 attach to truss 900. In order to provide additional strength for the anchor portion 912, a pair of support block wedges 950 is provided. The support blocks 950 each are configured to engage the top of the rafter 902 and the interior of shoulder portion 912. The support blocks 950 include an aperture 952 that is aligned with aperture 925 of the anchor portion to allow the support block 950 to be fastened to the gusset plates 910 by a fastener (not shown). The apertures 927 in the connection portion 922 provide anchor connection locations for users. It is noted that the support block edge 950 is shown with open sides and a closed bottom. This allows access such that the hard shaft of the support block fastener can be used as an alternative hook location for the security line carabiner.

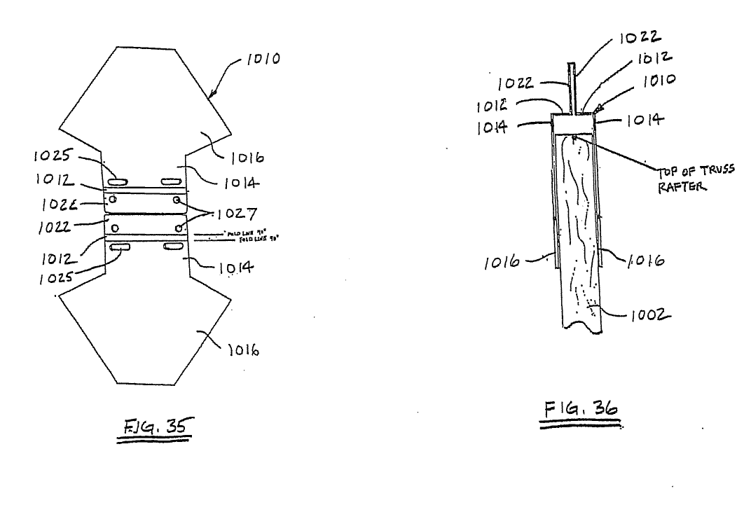

Another embodiment of the invention is shown in FIGS. 35 and 36 and is a double gusset version of the embodiment shown in FIGS. 32-34. A double peak gusset 1010 is shown that is manufactured as one piece and then folded prior to attachment to form the truss. Double peak gusset 1010 comprises a pair of shoulder portions 1012 and a pair of connection portions 1022 each having at least one aperture 1027, between the anchor portions 1014 of the double gusset 1010. The shoulder portions 1012 are folded inward from the anchor portions 1014 of the double gusset plate 1010 and connection portions 1022 are folded away from anchor portions 1014 such that connection portions 1022 and anchor portion 1014 are generally parallel to each other. A plurality of teeth (not shown) extends perpendicularly from each plate portion 1016. The double peak gusset 1010 is folded and attached to form a truss by the plurality of teeth (not shown) engaging the truss members 1002 as shown in FIG. 36. As with the previous embodiment, it is contemplated that support blocks 950 could be used to strengthen the anchor portion 1014.

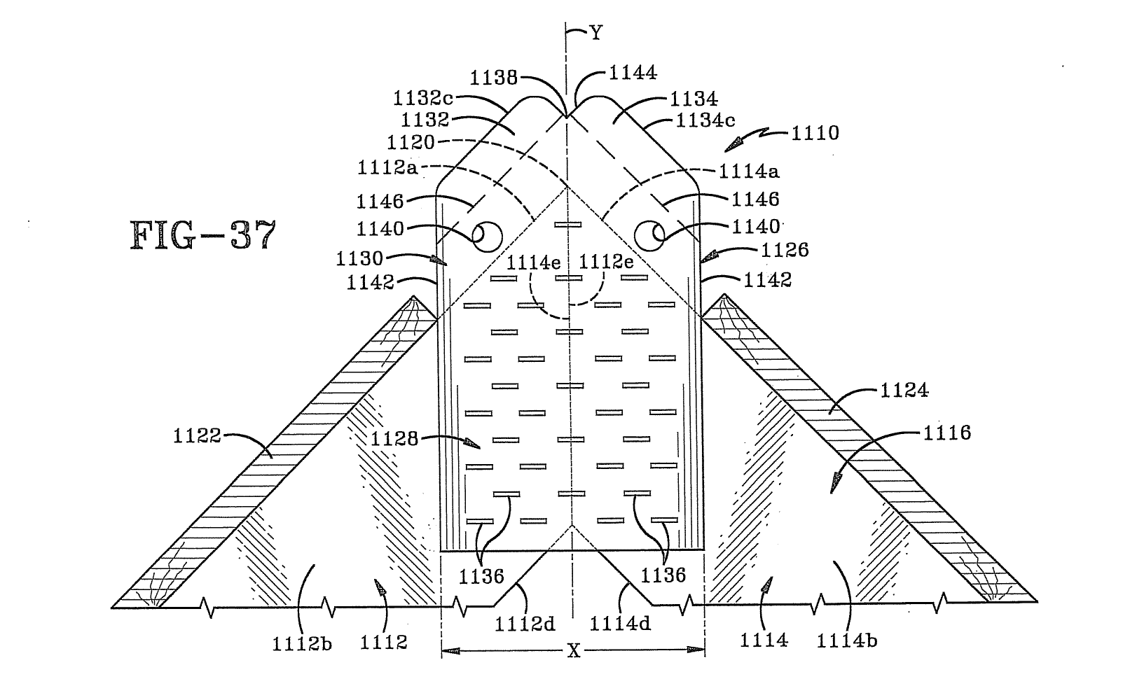

Referring to FIGS. 37-41, there is shown yet another embodiment of a peak gusset plate in accordance with the present invention and generally indicated at 1110. Peak gusset 1110 is designed to be permanently and non-removably secured to a roof truss at a manufacturing facility. The roof truss so formed includes a permanently available anchoring member for a security line for a roofer. FIG. 37 shows the uppermost region of a first roof truss 1116 that includes a first truss member 1112 and a second truss member 1114. First truss member 1112 has an upper surface 1112a, a side surface 1112b, an opposed second side surface 1112c, a bottom surface 1112d, and an angled end 1112e. Second truss member 1114 has an upper surface 1114a, a side surface 1114b, a second side surface 1114c, a bottom surface 1114d, and an angled end 1114e. Angled ends 1112e, 1114e are placed in abutting contact with each other so that first and second truss members 1112, 1114 form an apex or peak 1120. The peak gusset 1110 in accordance with the present invention is secured to a portion of side surface 1112b of first truss member 1112 and to a portion of side surface 1114b of second truss member 1114 adjacent the peak 1120 as will be hereinafter described. It will be understood, however, that truss 1116 may be constructed differently, such as having a molded top portion, which includes the peak 1120, and a plurality of truss members extending from this molded top portion.

In accordance with the present invention, peak gusset 1110 comprises a substantially planar steel plate 1126 that includes an attachment region 1128 and an anchor portion 1130. Peak gusset 1110 may also include a pair of flaps 1132, 1134 which may be provided to increase the strength of peak gusset 1110 and aid in preventing injury to persons working on the roof. Flaps 1132, 1134 may be omitted if the steel plate 1126 is of sufficient strength to support a security line. Attachment region 1128, anchor portion 1130 and flaps 1132, 1134 are integrally formed and coplanar with each other. Attachment region 1128 includes a plurality of gripping teeth that extend outwardly from a rear surface thereof and are disposed substantially at right angles thereto. The number 1136 in the attached figures indicates the region of teeth 1136 as seen from the front of peak gusset 1110 when attached to first roof truss 1116. Teeth 1136 are substantially identical to teeth 13 and are pressed into portions of side surfaces 1112b, 1114b during construction of truss 1116.

Anchor portion 1130 of peak gusset 1110 is integral with and extends outwardly away from attachment region 1128 and preferably is coplanar with attachment region 1128. Anchor portion 1130 preferably is generally triangular in shape, terminating in an apex 1138 that is aligned with peak 1120 of first truss 1116. Peak gusset 1110 has a longitudinal axis “Y” that extends through apex 1138 and is designed to be aligned with the abutting angled ends 1112e, 1114e of first and second truss members 1112, 1114. Anchor portion 1130 extends laterally outwardly away from peak 1120 as shown in FIG. 37 and may also extend vertically beyond peak 1120. Anchor portion 1130 preferably has an upper section that is substantially free of teeth or has minimal numbers of teeth. This upper section is designed to be disposed laterally above upper surfaces 1112a, 1114a. Anchor portion 1130 may extend vertically above and laterally outwardly beyond peak 1120 and therefore is not and does not need to be directly secured to first roof truss 1116 other than by way of attachment region 1128.

In accordance with a specific feature of the present invention, a pair of holes 1140 is defined in the upper section of anchor portion 1130. Holes 1140 are spaced a distance horizontally apart from each other and a short distance inwardly of side edges 1142 of anchor portion 1130. Holes 1140 are also spaced a distance inwardly from flaps 1132, 1134. Holes 1140 are aligned with each other and are disposed along a horizontal axis that is at right angles to the longitudinal axis “Y” of peak gusset 1110. Holes 1140 are positioned so that when attachment region 1128 is secured to truss 1116, holes 1140 will be positioned vertically above upper surfaces 1112a, 1114a of the first and second truss members 1112, 1114 and vertically beneath the apex 1120 of first truss 1116.

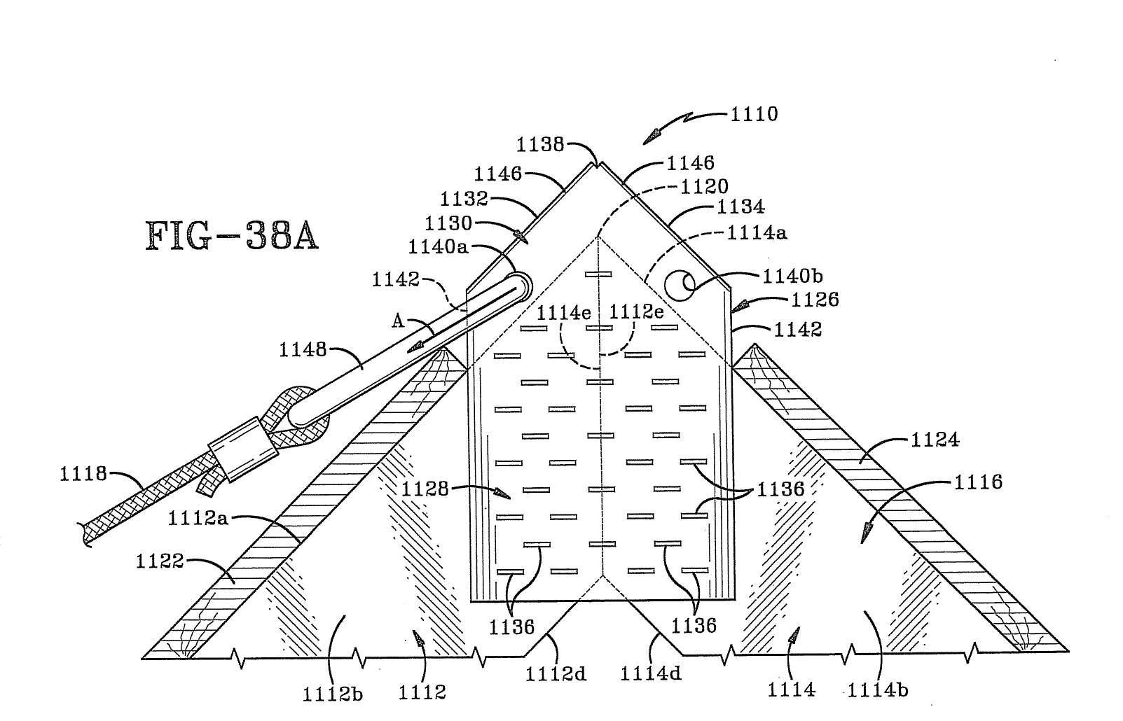

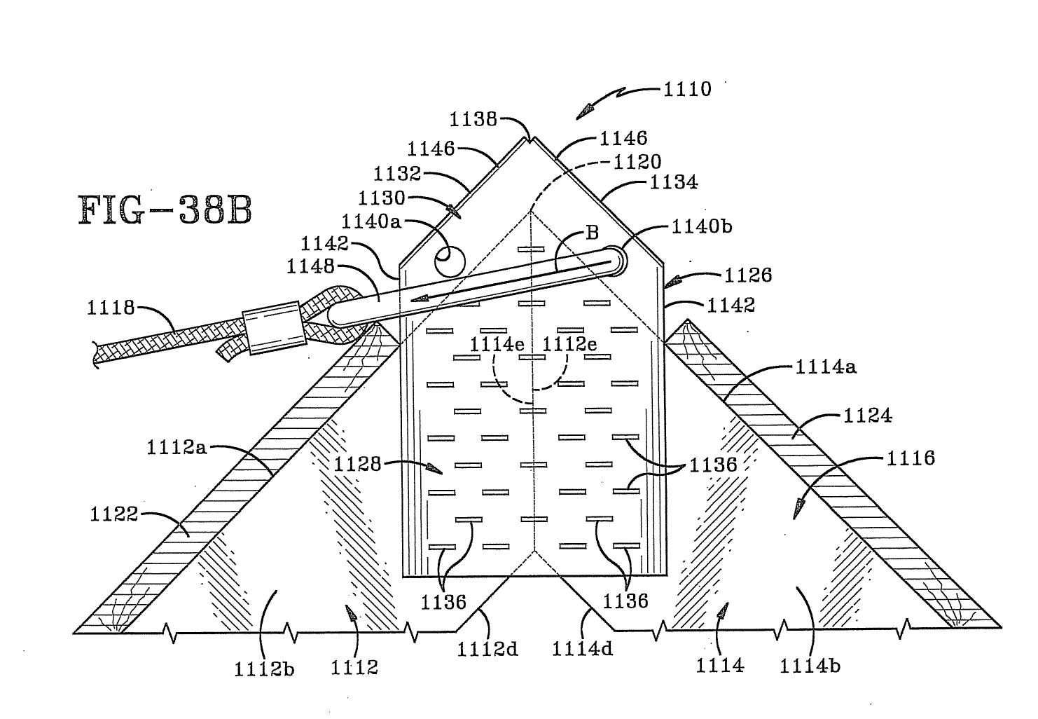

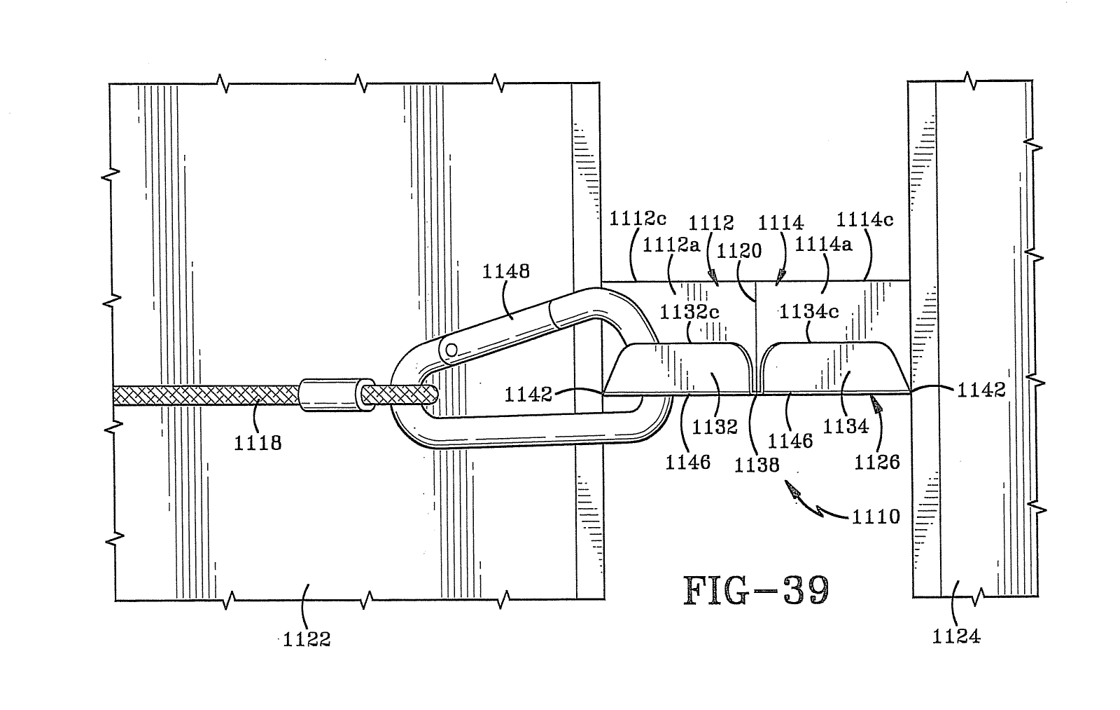

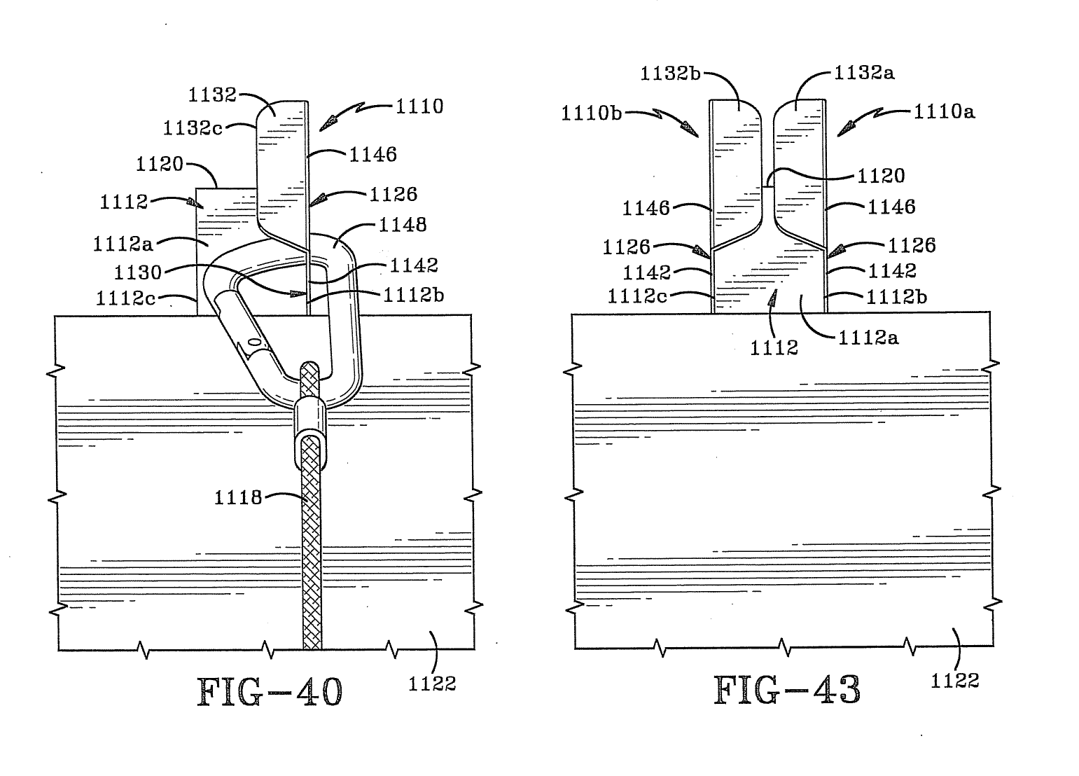

Flaps 1132, 1134 are integral with anchor portion 1130 and extend outwardly away therefrom. These flaps add metal strength and resistance to peak gusset 1110. Flaps 1132, 1134 may be left coplanar with and extended outwardly away from anchor portion 1130 as shown in FIG. 37. Each flap 1132, 1134 is provided with an arcuate or rounded outermost edge 1132c, 1134c so as not to present any sharp edges or corners on which a roofer may injure himself when the flaps are in this coplanar position. Flaps 1132, 1134 may be separated from each other by a small space 1144 proximate apex 1138 of anchor portion 1130. Space 1144 permits each flap 1132, 1134 to be individually bent about a fold line 1146 and out of alignment with anchor portion 1130. Alternatively, instead of providing a space 1144 between flaps 1132, 1134, they may be overlapped (not shown) to offer more metal strength to peak gusset 1110. Flaps 1132, 1134 may be bent through ninety degrees and into a first position where they extend outwardly at right angles to anchor portion 1130. It will be understood that flaps may be bent through ninety degrees and in a direction where they extend over the wood truss members 1112, 1114 as shown in FIGS. 38 and 39, or they may be bent through ninety degrees in the opposite direction and therefore away from truss members 1112, 1114 (not shown). When flaps 1132, 1134 are bent into the first position, the rounded upper edge formed along the fold line 1146 presents a smooth surface that ensures a roofer is less likely to injure himself on peak gusset 1110. The steel selected for peak gusset 1110 is, of course, of a sufficient strength to enable just a single peak gusset to be utilized as a securing anchor. The steel might therefore require tempering or might need to be of increased thickness, at least in the region of anchor portion 1130. Although not illustrated in the attached drawings, one method of achieving an increase in the steel thickness in the anchor portion region would be to bend flaps 1132, 1134 through 180 degrees so that they are in a second position. It will be understood that this bending can be accomplished in a first direction where flaps 1132, 1134 are bent so that they abut the rear surface of peak gusset 1110 or in a second direction where they abut the front surface of peak gusset. Apertures will then have to be punched through both flaps 1132, 1134 so as to align with holes 1140 in anchor portion 1130. This will double the strength of the material around holes 1140 and reduce the possibility of failure of peak gusset 1110. In this second position, fold line 1146 in gusset 1110 would again be smooth and rounded to aid in preventing possible accidents. It will be understood that flaps 1132, 1134 may be put into either of the first and second positions at the manufacturing facility or at the building site.

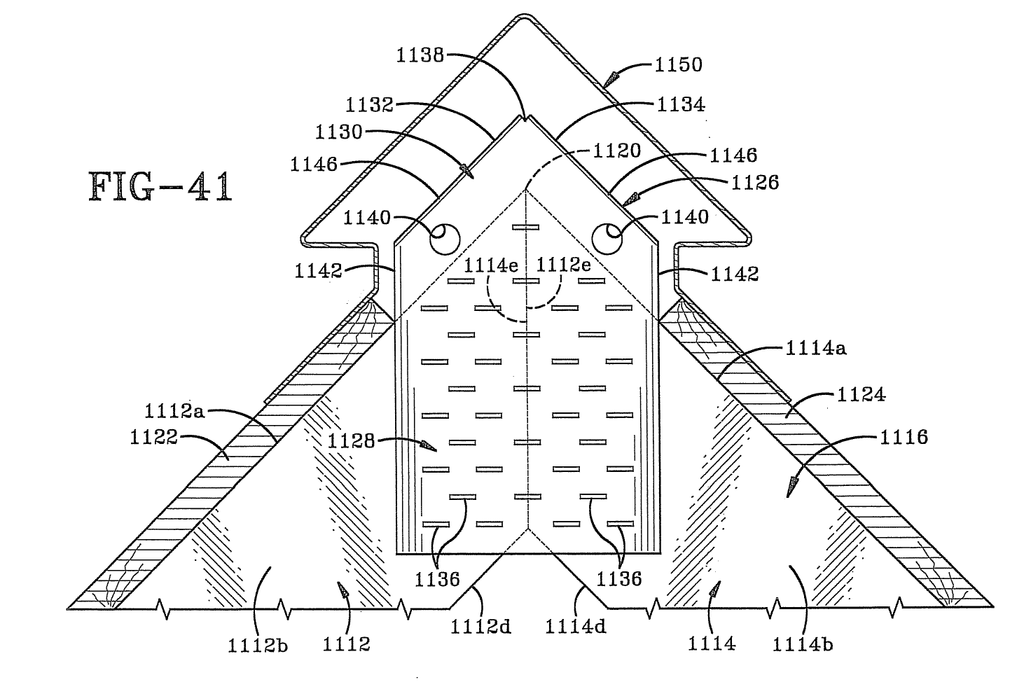

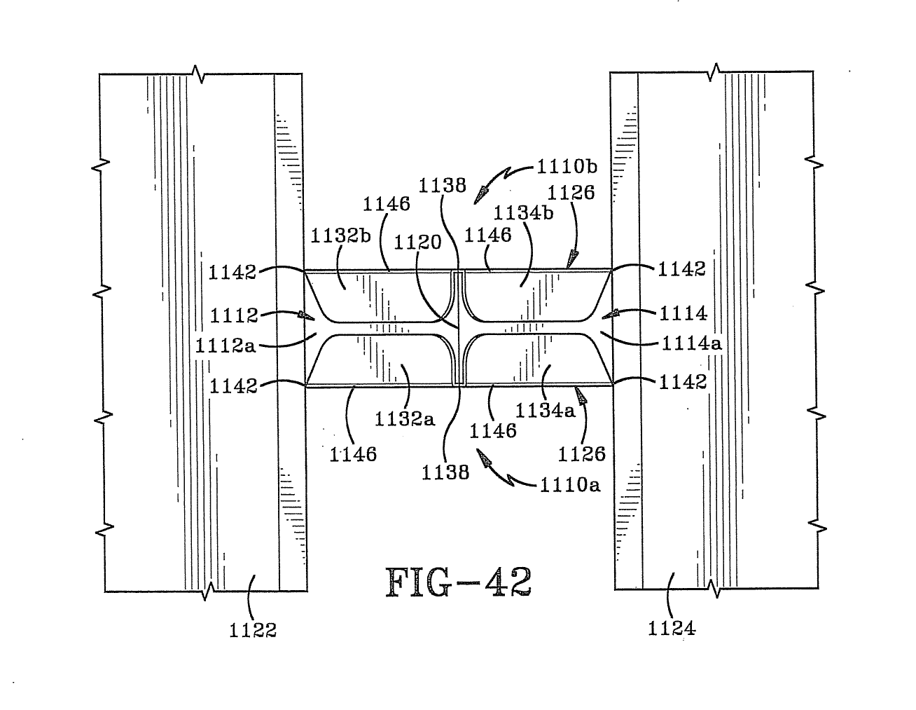

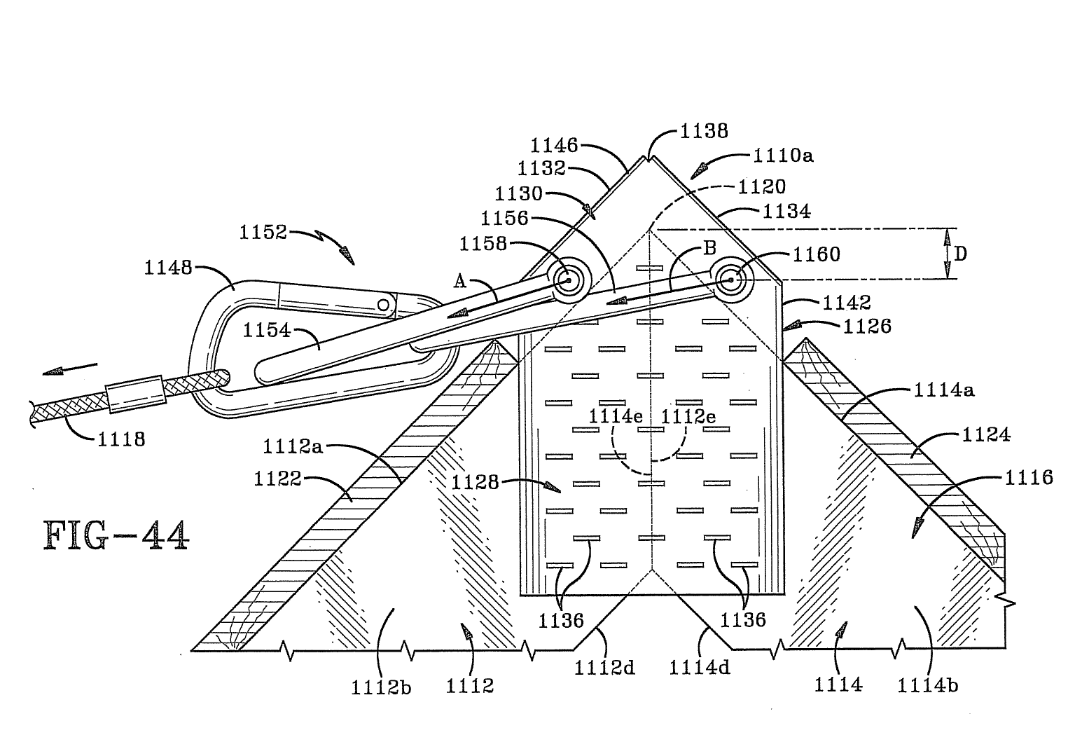

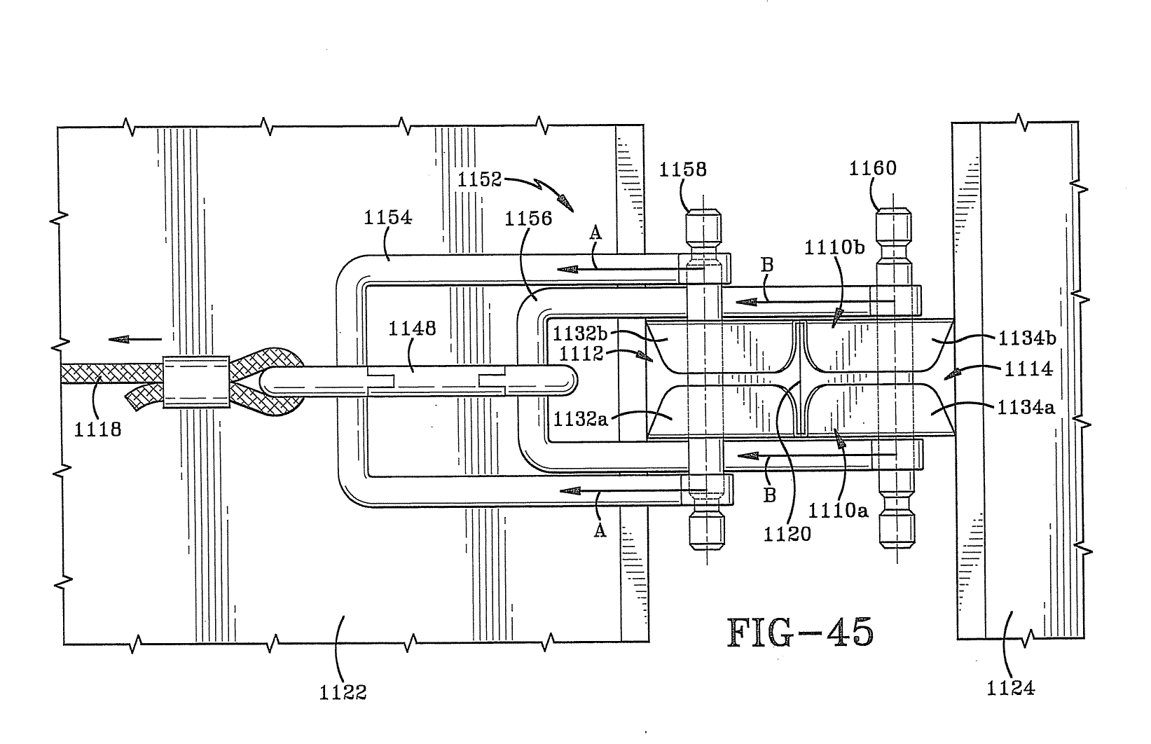

The peak gusset 1110 of the present invention is used as part of an anchoring system that includes gusset 1110, and a security line 1118. The roof being constructed requires the use of a plurality of roof trusses that are substantially identical to first roof truss 1116, each truss having a peak gusset 1110 secured thereto. The plurality of roof trusses can be considered to have a longitudinal axis that extends horizontally through the aligned peaks of the trusses. Each peak gusset 1110 is secured to one of the plurality of roof trusses substantially at right angles to this longitudinal axis. Once all of the roof trusses 1116 are mounted to the wall framing, planar sheets of material, such as plywood sheets, are secured thereto and shingles are applied thereon. FIG. 37 shows a first sheet member 1122 secured to upper surface 1112a of first truss member 1112 and a second sheet member 1124 secured to upper surface 1114a of second truss member 1114. Sheet members 1122, 1124 do not extend all of the way to peak 1120 but, instead, have an edge that terminates a short distance away therefrom. Consequently, a gap is formed between the edges of sheet members 1122, 1124 and this gap is of a width “X”. The gap allows hot air trapped in the roof to escape from beneath sheet members 1122, 1124. The gap, which runs substantially the entire length of the roof, is ultimately covered by a ventilation cap 1150 (FIG. 41) as will be hereinafter described. Peak gusset 1110 is of a width suitable to be received in the gap between the ends of sheet members 1122, 1124. Peak gusset 1110 may be sized to be complementary to the gap and therefore have a width substantially equal to “X”. Alternatively, gusset 1110 may be of a slightly smaller width than “X”. It will be understood the sheet members 1122, 1124 are secured to truss 1116 and to a second truss (not shown) that is spaced a distance horizontally apart from truss 1116. First sheet member 1122 extends between coplanar first upper walls of the first and second trusses; and second sheet member 1124 extends between coplanar second upper walls of the first and second trusses. The gap runs between the edges of these first and second sheets from the first truss to the second truss. A second, substantially identical gusset plate may be installed in a substantially identical manner to the manner described with reference to gusset plate 1110.

When a roofer is ready to roof the building, he attaches a first connector (not shown) at a first end of security line 1118 to a harness that he is wearing. He also attaches a carabiner 1148 that is at a second end of security line 1118 to one of the holes 1140 of peak gusset 1110. As shown in FIG. 38a, carabiner 1148, with security line 1118 attached thereto, may be secured through hole 1140a in peak gusset 1110. In this instance, hole 1140a is on the same side of the roof as the roofer and the line of force on peak gusset 1110 is indicated by arrow “A”. Alternatively, as shown in FIG. 38b, carabiner 1148 may be secured through hole 1140b on peak gusset 1110. Hole 140b is on the opposite side of peak gusset 1110 from the position of the roofer on the roof. Consequently, the line of force “B” will be directed through the wood of the peak 1120 of the truss 1116. Thus, truss 1116 itself aids in acting as a support for the roofer. The roofer can install sheet members 1122, 1124 and shingles (not shown) in relative safety while attached via security line 1118 to peak gusset 1110. As he moves to the next section of the roof, he can detach carabiner 1148 from peak gusset 1110 on roof truss 1116 and attach the same to a peak gusset installed on another roof truss. Although not illustrated in FIGS. 37-41, an anchoring device may be applied to security line 1118 in place of carabiner 1148 and which is receivable through both holes 1140a, 1140b on peak gusset 1110.

It should be noted that peak gusset 1110 is not removed once the roof is completed. Because holes 1140 are beneath peak 1120 of truss 1116, they are always available for attachment of a carabiner 1148 thereto. Anchor portion 1130 does not need to be cut down in order to install ventilation cap 1150 thereover as shown in FIG. 41. It will be understood that if flaps 1132, 1134 have not been previously bent out of alignment with anchor portion 1130, they may be bent through 90° in order to reduce the height of peak gusset 1110 before ventilation cap 1150 is secured to sheet members 1122, 1124. Ventilation gap 1150 will therefore span the gap between first and second sheet members 1122, 1124 and between a first and a second truss member.

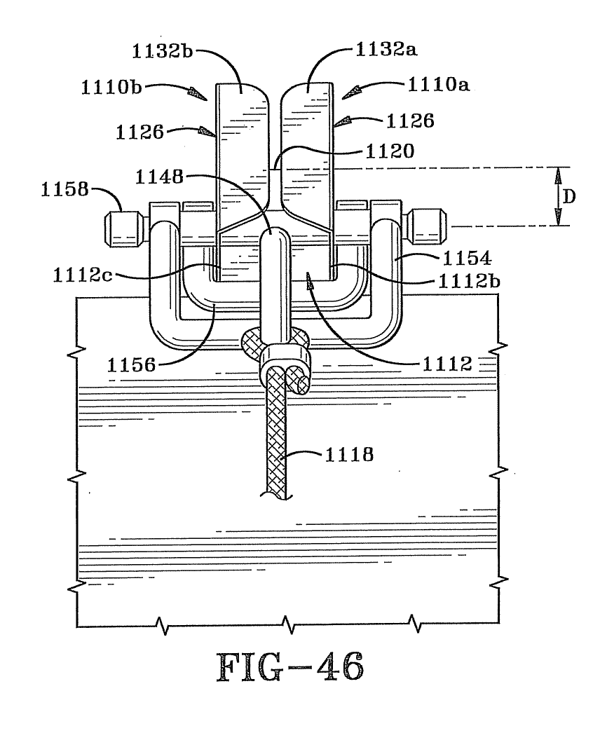

FIGS. 42-46 show that a pair of peak gussets 1110a, 1110b may be used to secure truss members 1112, 1114 together and to provide an anchoring point for an anchoring system 1152. Peak gussets 1110a, 1110b are substantially identical to each other. Peak gusset 1110a is applied to a first side surface 1112b, 1114b of truss members 1112, 1114 and peak gusset 1110b is applied to the opposing second side surface 1112c, 1114c thereof. Flaps 1132a, 1134a on peak gusset 1110a may be folded inwardly over truss members 1112, 1114 and flaps 1132b, 1134b are folded inwardly in the opposite direction. Consequently, first flap 1132a on first peak gusset 1110a extends toward first flap 1132b of second peak gusset 1110b, and second flap 1134a on first peak gusset 1110a extends toward second flap 1134b of second peak gusset 1110b. Furthermore, the holes 1140 on first peak gusset 1110a align with holes in the second peak gusset 1110b.

Anchoring system 1152 includes a first connector 1156 and a second connector 1154. A bolt 1160 of first connector 1156 is inserted through a first pair of aligned holes (not numbered) in the first and second peak gussets 1110a, 1110b. A bolt 1158 of second connector 1154 is inserted through a second pair of aligned holes (not numbered) in the first and second peak gussets 1110a, 1110b. As shown in FIG. 44, both bolts 1158, 1160 are spaced a distance “D” vertically beneath peak 1120 of truss 1116. A carabiner 1148 engages both of the first and second connectors 1156, 1154 and a security line or cable 1118 is connected to carabiner 1148. As illustrated in FIG. 44, the line of force “B” for the first connector 1156 passes substantially through a portion of the wood of truss 1116 beneath peak 1120, thus strengthening the anchoring system. First connector 1156 may also rest on sheet member 1122 which is secured to the truss member 1112. The support which the peak gussets 1110a, 1110b can therefore provide is enhanced by the contact with these pieces of sheet material. The presence of two peak gussets 1110a, 1110b causes the forces from anchoring system 1152 to be more evenly distributed across truss peak 1120.

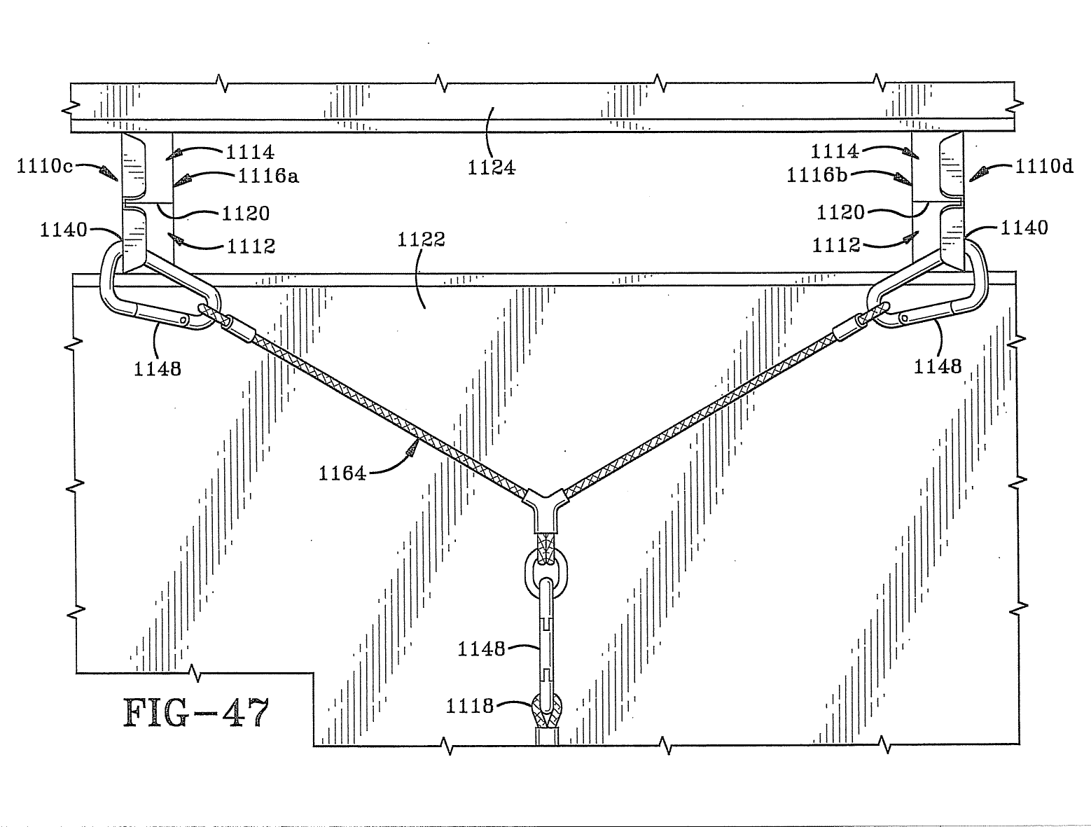

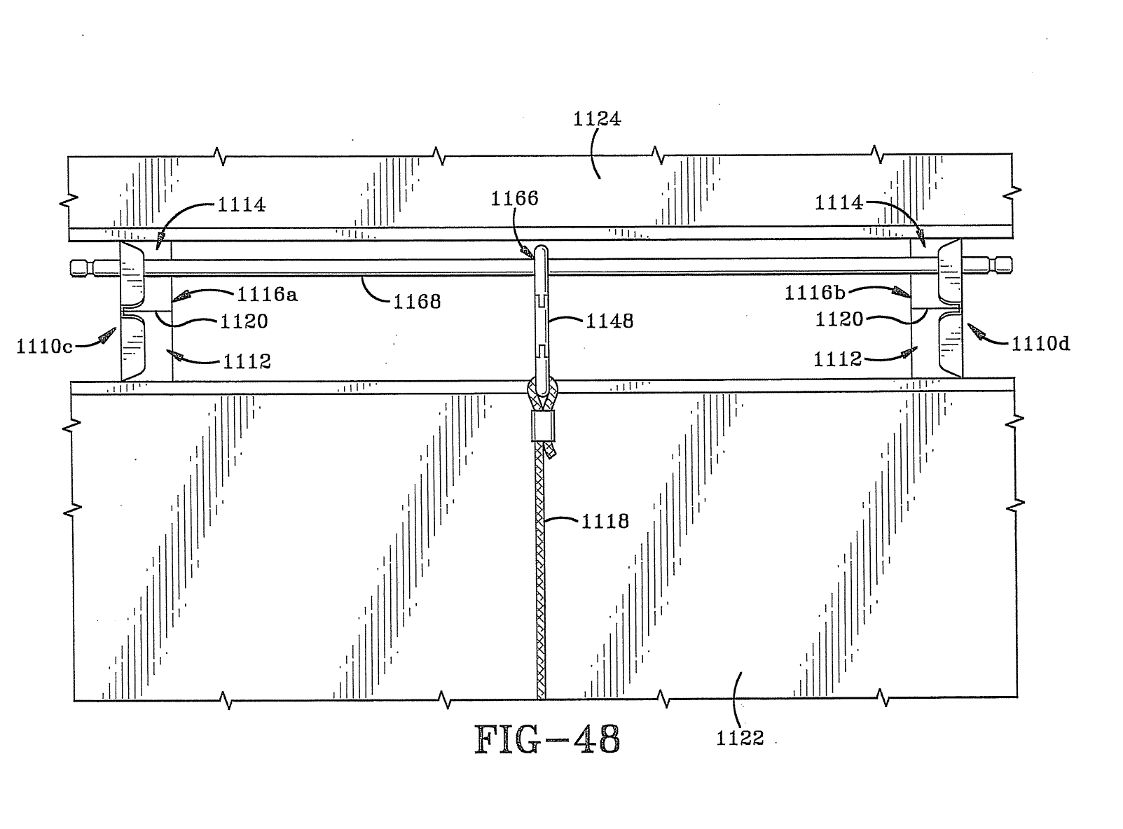

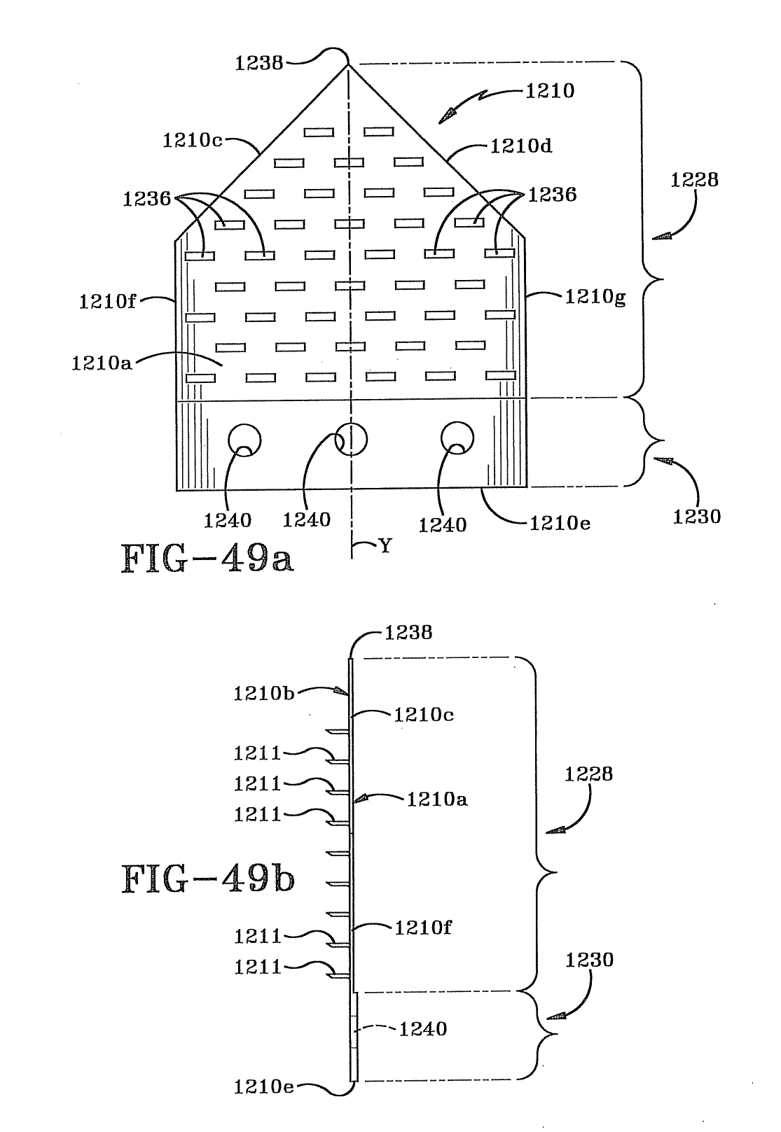

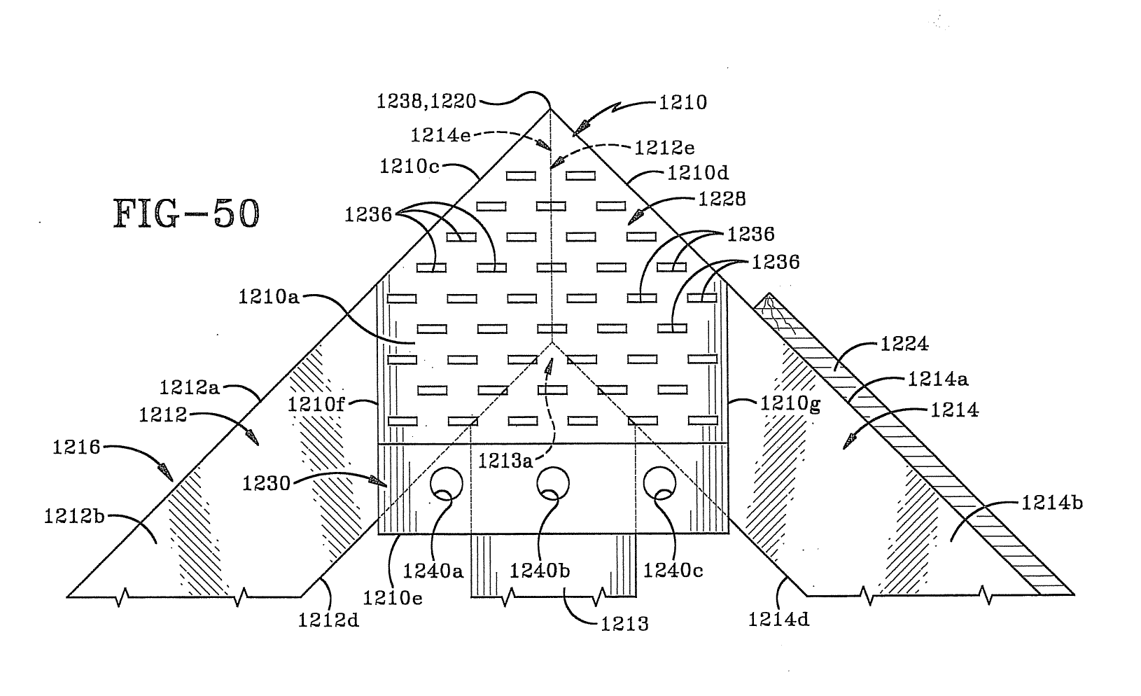

FIGS. 47 & 48 show a roof anchor system which extends between a first truss 1116a and a second truss 1116b. Each of the first and second trusses 1116a, 1116b has a single or double set of peak gussets 1110 secured thereto. In these figures, a single peak gusset 1110c is secured to first truss 1116a and another single peak gusset 1110d is secured to second truss 1116b. Preferably the first hole in the first peak gusset 1110c aligns with the first hole in the second peak gusset 1110d, and the second hole in the first peak gusset 1110c aligns with the second hole in the second peak gusset 1110d. A connector member extends between the hole in the peak gusset 1110c on the first truss 1116a and the hole aligned therewith in the peak gusset 1110d on the second truss 1116b. The connector member may take the form of a Y-cable 1164, such as is shown in FIG. 47 or a rod 1168 shown in FIG. 48. A primary hitch point 1166 is provided along rod 1168 and a carabiner 1148 is secured to hitch point 1166 opposite the side of the roofline on which the roofer is working. Because the holes in peak gussets 1110c, 1110d are beneath peaks 1120 of first and second trusses 1116a, 1116b, the connector member, i.e., the cable 1164 or rod 1168, is also positioned beneath peaks 1120. The line of force exerted on the security line 1118 therefore passes through at least a portion of the wood of truss members 1112, 1114.

Referring to FIGS. 49a-52 there is shown yet another embodiment of a gusset plate in accordance with the present invention and generally indicated at 1210. Gusset plate 1210 may be used as a roof ridge gusset plate or as an off-ridge plate for securing members of a roof truss together. Gusset plate 1210 also provides a means for anchoring a security line as will be hereinafter described.

Gusset plate 1210 comprises a metal plate that has a front surface 1210a, a rear surface 1210b, a first edge comprised of first and second sections 1210c and 1210d, a second edge 1210e opposed to the first edge, and first and second sides 1210f, 1210g that extend between the first and second edges. The first section 1210c of the first edge originates at one end of first side 1210f and extends outwardly therefrom and at an angle to first side 1210f. The second section 1210d of the first edge originates at one end of second side 1210g and extends outwardly therefrom and at an angle to the second side 1210g. The first and second sections 1210c, 1210d meet at an apex 1238 that is equidistant from each of first and second sides 1210f, 1210g. Gusset plate 1210 has a longitudinal axis “Y” that runs through apex 1238 and generally along a midline of the plate (FIG. 49a).

In accordance with a specific feature of the present invention, gusset plate 1210 includes an attachment region 1228 and an anchor portion 1230 that are generally coplanar with each other. Attachment region 1228 is disposed on the plate adjacent the first and second sections 1210c, 1210d of the first edge and extends for a distance inwardly therefrom and toward the second edge 1210e. Attachment region 1228 includes a plurality of gripping teeth 1211 that project outwardly for a distance from rear surface 1210b and generally at right angles thereto. The number 1236 in FIGS. 49a-52 indicates regions on front surface 1210a that correspond to the regions on the rear surface 1210b where teeth 1211 are located. Teeth 1211 are substantially identical to the teeth 13 of the first embodiment of the gusset plate 10 and are shaped so as to be pressed into the wood used to construct a truss 1216. The area of attachment region 1228 adjacent the first edge is substantially triangular in shape and preferably is complementary in shape to the peak of the truss 1216 which it is designed to connect together. The apex of the attachment region is used when the number of teeth required to secure the truss member necessitates the use of that area. It will be understood that gusset plate 1210 may be generally rectangular in shape or may be of any other shape suitable for securing first and second truss members 1212, 1214 together. If gusset plate 1210 is used in an off-ridge situation, for example, the first edge thereof may be configured complementary to the uppermost region of the truss to which it is to be attached.

Anchor portion 1230 of gusset plate 1210 is disposed on the plate adjacent the second edge 1210e and extends for a distance inwardly therefrom and toward the first edge. Anchor portion 1230 is integral with attachment region 1228 and preferably is coplanar therewith. Anchor portion 1230 preferably is substantially free of teeth or has minimal numbers of teeth. Alternatively, anchor portion 1230 may include teeth that may or may not be engaged with the wood of truss 1216.

In accordance with yet another specific feature of the present invention, one or more holes are defined in anchor portion 1230. FIG. 49a shows three holes 1240a, 1240b, 1240c defined in anchor portion 1230 and spaced a distance apart from each other. Holes 1240a-1240c are shown horizontally aligned with each other and located and a short distance inwardly from second edge 1210e. Holes 1240 may be disposed substantially parallel to the second edge 1210c or may be in a staggered pattern relative to each other. Hole 1240b is positioned on the midline of gusset plate 1210. Hole 1240a is disposed intermediate hole 1240b and first side 1210f. Hole 1240c is disposed intermediate hole 1240b and second side 1210g.

Although it is not illustrated in FIGS. 49a-52, it will be understood that gusset plate 1210 may also be provided with flaps that extend outwardly from the first and second sections 1210c, 1210d of the first edge. These flaps would be similar in nature and function to those shown in FIG. 37. Gusset plate 1210 may further be provided with a flap that extends outwardly from second edge 1210e to provide additional strength to that region of the plate.

As with the previous embodiments, gusset plate 1210 is designed to secure first and second truss members 1212, 1214 together during the construction of a truss 1216. It will be understood that a single gusset plate 1210 may be used for this purpose. Alternatively, a pair of single gusset plates, such as gussets 1210, 1210A may be used for this purpose. First truss member 1212 has an upper surface 1212a, a first side surface 1212b, a second side surface 1212c, a bottom surface 1212d and an angled end 1212e. Similarly, second truss member 1214 has an upper surface 1214a, a first side surface 1214b, a second side surface (not shown), a bottom surface 1214d and an angled end 1214e. The angled ends 1212e, 1214e are placed in abutting contact with each other. Gusset plate 1210 is then positioned so that its rear surface 1210b is positioned on first side surfaces 1212b, 1214b such that the longitudinal axis “Y” of gusset plate 1210 is aligned along the abutting ends 1212e, 1212f. Gusset plate 1210 is positioned so that teeth 1211 of attachment region 1228 contact first side surfaces 1212b, 1214b and the anchor portion 1230 of gusset plate 1210 is disposed substantially free of contact with first side surfaces 1212b, 1214b. Furthermore, holes 1240a-1240c of anchor portion 1230 are disposed so that they are disposed between bottom surfaces 1212d and 1214d of first and second truss members 1212, 1214. Gusset plate 1210 is then pressed inwardly toward first surfaces 1212b, 1214b such that teeth 1211 bite into the surfaces and thereby secure first and second truss members 1212 and 1214 together. It should also be noted that when gusset plate 1210 is positioned on first and second truss members 1212, 1214, the apex 1238 of gusset plate 1210 is substantially aligned with the peak 1220 of the first and second truss members 1212, 1214.

Attachment region 1228 does not extend vertically above and laterally outwardly beyond peak 1220 or upper surfaces 1212a, 1214a of first and second truss members 1212, 1214. Preferably, and as shown in FIG. 50, gusset plate 1210 may also be at least partially attached to an upper end 1213a of a king post 1213 that forms part of truss 1216. King post 1213 extends downwardly away from bottom surfaces 1212d, 1214d of first and second truss members 1212, 1214. When gusset plate 1210 is positioned on first and second truss members 1212, 1214, the anchor portion 1230 is oriented laterally relative to peak 1220 and is disposed vertically downward therefrom. Furthermore, anchor portion 1230 is positioned so that holes 1240a and 1240c fall intermediate lower surfaces 1212d, 1214d of first and second truss members 1212, 1214 and on either side of king post 1213. Holes 1240a and 1240c are therefore available for the securement of a security line to gusset plate 1210 as will be hereinafter described. If truss 1216 does not include a king post 1213, then all three holes 1240a, 1240b and 1240c are available for securement of a security line to gusset plate 1210.

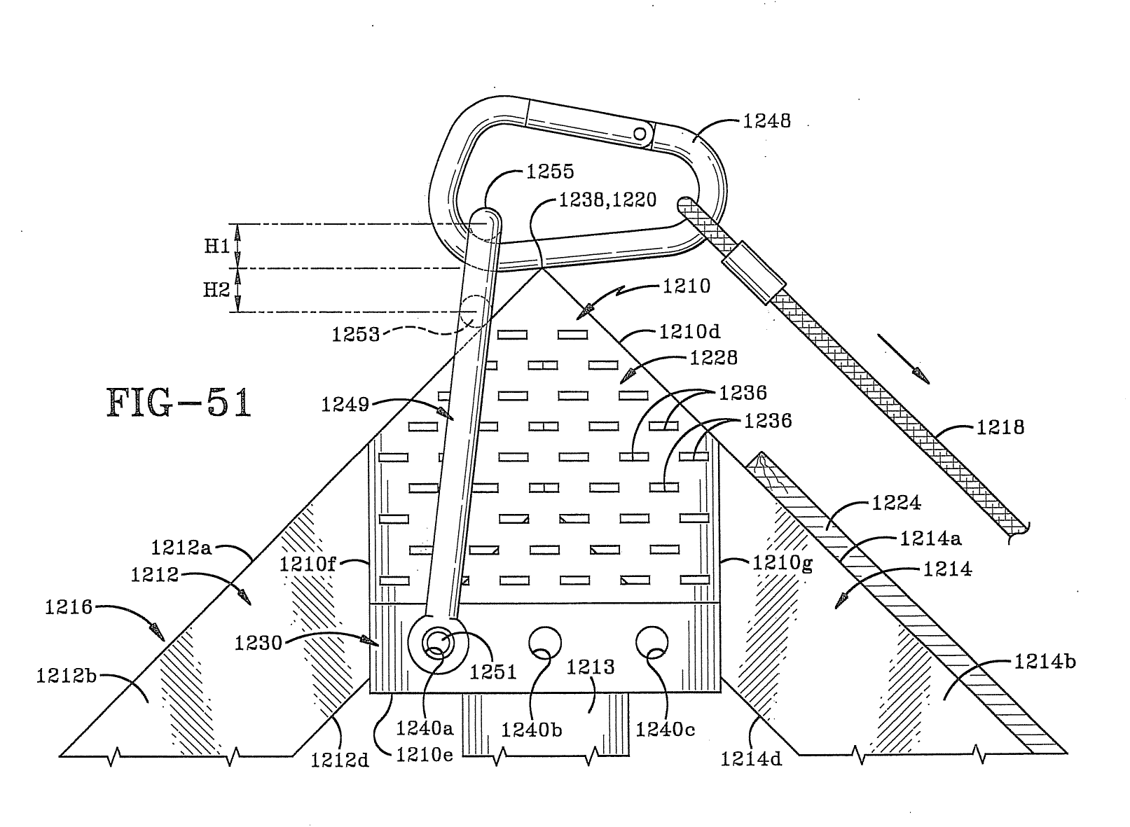

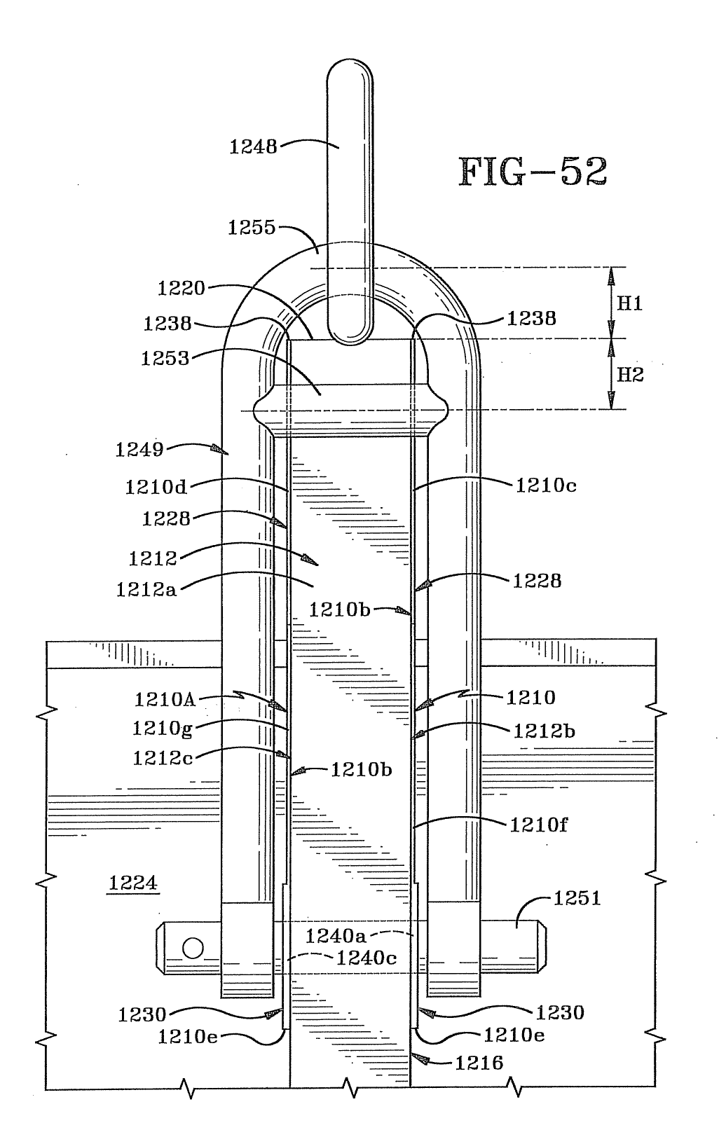

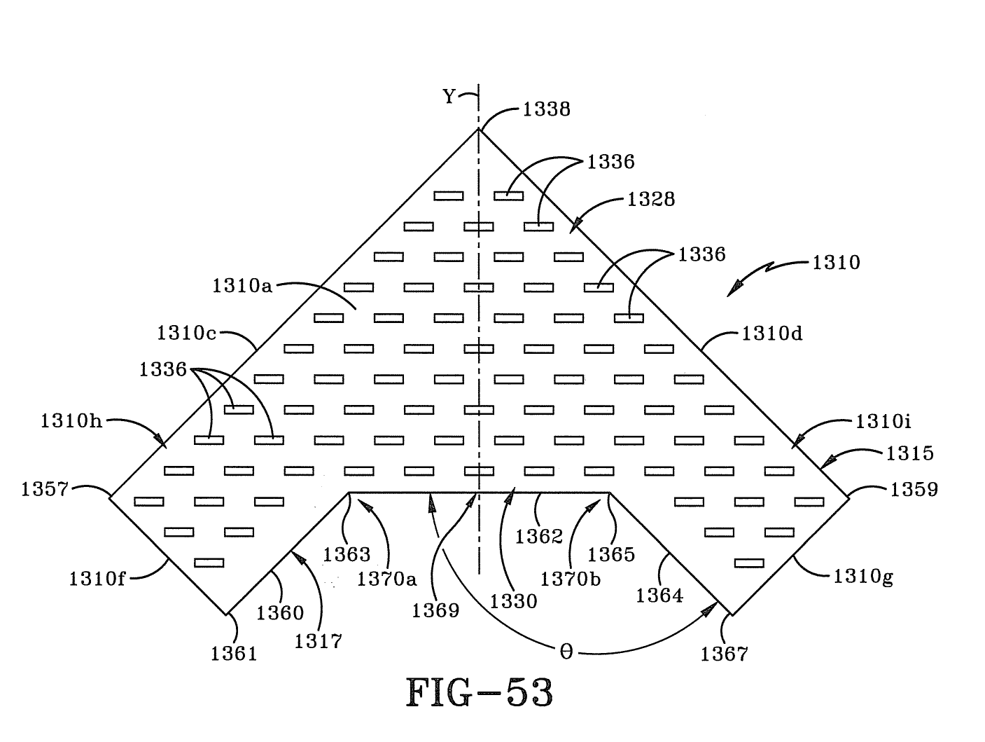

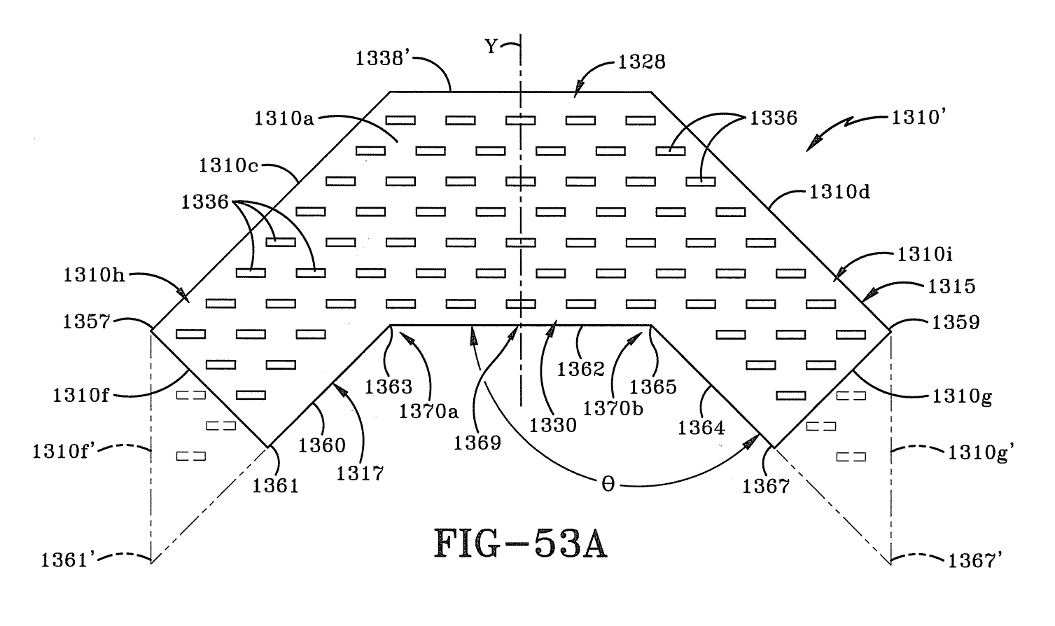

Gusset plate 1210 is designed to be permanently secured to roof truss 1216 at a manufacturing facility and is not removable from truss 1216 once the roof has been constructed. The roof truss 1216 so constructed therefore includes a permanently available anchoring member for attachment of a security line 1218 for a roofer. As was previously described herein, the roof being constructed on a building incorporates a plurality of roof trusses 1216. Each truss 1216 is substantially identical to roof truss 1216 and each truss includes a permanently attached gusset plate 1210. Once all of the roof trusses 1216 are mounted to the wall framing for the building, planar sheets of material, such as plywood sheets, may be secured thereto and shingles applied thereover. FIG. 51 illustrates a first sheet member 1224 secured to upper surface 1214a of second truss member 1214. Sheet member 1224 does not extend all of the way to peak 1220 but, instead, has an upper edge that terminates a short distance away therefrom. Consequently, when sheet members are secured to each of the upper surfaces 1212a, 1214a of first and second truss members 1212, 1214, a gap is formed between the upper edges of those sheet members. The gap allows hot air trapped in the roof to escape from beneath the sheet members. Gusset plate 1210 is of a width between its first and second sides 1210f, 1210g such that it is suitable to be received in the gap between the upper edges of the sheet members 1224. Preferably, as illustrated in FIG. 52, a second, substantially identical gusset plate 1210A is installed on the second side surface 1212c of first truss member 1212 and the second side surface (not shown) of second truss member 1214. Second gusset plate 1210A is positioned so that the holes 1240 in second gusset plate 1210A align with the holes 1240 in the gusset plate 1210.

FIGS. 50-52 illustrate the use of gusset plate 1210 secured to first and second truss members 1212, 1214 at the peak of a roof truss. It will be understood, however, that a gusset plate or a pair of gusset plates in accordance with the present invention could be utilized to secure other regions of the truss together and could be utilized as part of a security line anchoring system in this alternative location. Furthermore, a gusset plate or a pair of gusset plates in accordance with the present invention may be secured at any location on any one of the members of the truss, even on only one of the first and second truss members if the gusset plate(s) are simply to be utilized as a part of a security line anchoring system. In other words, the gusset plate or pair of gusset plates does not need to be utilized to secure two truss members together. The single plate or pair of plates may, instead, simply be attached to one member of a truss and in any location on the truss in order to provide a secure connection for a security line as part of an anchoring system. In any of these abovementioned locations, at least an area of the anchor portion of the gusset plate, or gusset plates, extends beneath the truss member(s) with which the plate(s) are engaged. Furthermore, one or more holes for connecting the security line to the gusset plate(s) are disposed in this area of the anchor portion.

FIGS. 51 & 52 illustrate an anchoring system for a roofer in accordance with the present invention. The anchoring system includes gusset plate 1210, a D-shaped shackle 1249, a carabiner 1248 and a security line 1218. It will be understood that a single gusset plate 1210 may be utilized in the anchoring system in accordance with the present invention or a pair of gusset plates 1210, 1210A may be utilized without departing from the spirit of the present invention. FIG. 52 shows shackle 1249 secured to two gusset plates 1210, 1210A, but it will be understood that only a single gusset plate 1210 may be provided on truss 1216 and that shackle 1249 would be therefore secured to that single gusset 1210. Alternatively, two gusset plates 1210, 1210A may be provided on truss 1216 and shackle may be engaged with only one of those gussets 1210, 1210A. The following description relates to shackle 1249 being secured to a pair of gussets 1210, 1210A.

When a roofer is ready to roof the building, he attaches a first connector (not shown) to a first end (not shown) of a security line 1218 to a harness that he is wearing. He then engages the “D-shaped” shackle 1249 with gusset plates 1210 and 1210A. Shackle 1249 includes a pin 1251, a crossbar 1251 and a top end 1255. Pin 1251 is inserted through aligned holes 1240a, 1240c in peak gussets 1210, 1210A, respectively. If holes 1240 are formed in a staggered pattern in the anchor regions of peak gussets 1210, 1210A, then the roofer is able to select the optimum D-shackle pin location for correct alignment of crossbar 1251 with the upper surface 1212a of first truss member 1212. Preferably, shackle 1249 is engaged with the aligned holes 1240a that are on the opposite side of the peak 1220 from where the roofer intends to work. Carabiner 1248 at the second end of security line 1218 is secured to shackle 1249 between top end 1255 and crossbar 1253.

It should be noted that top end 1255 of shackle preferably is disposed at a first height H1 above the peak 1220 of truss 1216 and apex 1238 of gusset plate 1210 when the anchoring system is in use. Furthermore, crossbar 1253 of shackle 1249 is disposed at a second height H2 below the peak 1220 and apex 1238 when the anchoring system is in use. Preferably, H1 is one inch above peak 1220 and H2 is one inch below peak 1220. This arrangement enables crossbar 1253 of shackle 1249 to securely contact the wood of truss 1216 while positioning top end 1255 of shackle 1249 at a height suitable to permit carabiner 1248 and security line 1218 to cross the peak 1220. It may prove advantageous for attachment region 1228 to be substantially triangular in shape and complementary to the shape of peak 1220, as gusset plate 1210 may thereby substantially prevent the wood of truss 1216 at peak 1220 from splitting because of the forces brought to bear thereon by crossbar 1253 of shackle 1249.

In the instance illustrated in FIGS. 51 and 52, holes 1240a are on the opposite side of the roof from the roofer and, consequently, the lines of force on gusset plate 1210 are directed through the wood of peak 1220 and additionally through the wood of king post 1213. Thus, truss 1216 and king post 1213 aid in acting as a support for the roofer. The roofer can therefore install sheet member 1224 and shingles (not shown) in relative safety while attached via security line 1218 to gusset plate 1210. As the roofer moves to the next section of the roof, he will detach shackle 1249 and carabiner 1248 from gusset plates 1210, 1210A and reattach the same to a similar pair of gusset plates installed on another roof truss. It should be noted that gusset plates 1210, 1210A remain in place and are not removed once the roof is completed.

When the roofer is going to apply sheet material to first truss member 1212, he disengages shackle 1249 from hole 1240a in anchor portion 1230 of plate and engages first pin 1251 in hole 1240c of gusset plate 1210. When shackle 1249 is so engaged, crossbar 1253 will engage upper surface 1214a of second truss member 1214 and carabiner 1248 and security line 1218 will clear peak 1220 and apex 1238 and extend downwardly over upper surface 1212a of first truss member 1212. Once again, crossbar 1253 will engage upper surface 1214a of second truss member 1214 approximately 1 inch below the peak 1220 and top end 1255 of shackle 1249 will be disposed approximate 1 inch above the peak.

It will be understood that if truss member 1216 includes king post 1213, then the third hole 1240b will not be utilized to secure shackle 1249 and carabiner 1248 thereto. However, if the king post in not provided on a truss, then the third hole 1240b is also available for securing the shackle 1249 thereto.

One of the advantages of utilizing gusset plate 1210 is that the positioning of the holes 1240 below the lower surfaces 1212d, 1214d of truss member 1216 and some distance beneath peak 1220, causes the force applied to the shackle 1249 when supporting a person on the security line 1218 to be passed into both the king post 1213 and truss member 1216. The security line is therefore more firmly anchored than in previously known systems.

It will be understood that while the uppermost portion of gusset plate 1210 (comprised of first and second sections 1210c, 1210d and adjacent regions of first and second sides 1210f, 1210g) has been shown and described as being generally triangular in shape, this uppermost portion may be shaped differently without departing from the spirit of the present invention. For instance, the gusset plate may be substantially square or rectangular in overall shape—i.e. the first edge comprised of first and second sections 1210c, 1210 may be a straight edge so that the gusset plate has a flat top. Alternatively, the first edge may be irregular in shape or may be arcuate in shape. Thus, it will be understood that the shape of the top of the gusset plate may not be important in all applications. But, in some circumstances, use of a gusset plate as shown and described with a triangular upper region may be necessary to achieve adequate load capacity to secure the first and second truss members 1212, 1214 together.

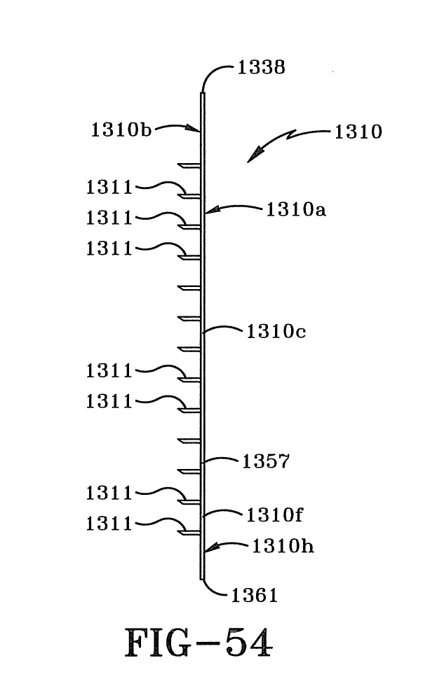

FIGS. 53-55 illustrate yet another embodiment of a gusset plate in accordance with the present invention and generally indicated at 1310. Gusset plate 1310 is useful as a roof ridge gusset plate for securing members of a roof truss together. Gusset plate 1310 also aids in strengthening the truss adjacent a peak 1320 so that the truss is able to adequately support a security line 1318, as will be hereinafter described.

Gusset plate 1310 comprises a substantially planar metal plate having a front surface 1310a (FIG. 54), a rear surface 1310b, and an outer perimeter. The outer perimeter includes a first edge 1315 providing a particular shape to gusset plate 1310 which may generally correspond to a particular roof peak shape. As shown in FIG. 53, gusset plate 1310 may have a generally V-shaped first edge 1315. Alternatively, as shown in FIG. 53A gusset plate 1310′ may have a generally inverted U-shaped first edge 1315. In accordance with a specific feature of the invention, first edge 1315 is preferably shaped to be complementary to a portion of the peak region proximate peak 1320 of the particular roof truss. Gusset 1310 will be referred to hereinafter as having a generally V-shaped first edge 1315 being complementary shaped to the entire peak region proximate peak 1320. However, first edge 1315 is not limited to such shape or restriction. First edge 1315 may be formed in any shape that acts to reinforce the region around peak 1320.

Gusset plate 1310 further includes a generally U-shaped second edge 1317 disposed opposite the V-shaped first edge 1315. As is evident from FIG. 53, the V-shape of the first edge 1315 and the U-shape of the second edge 1317 open in the same direction in such a manner that the U-shape appears to nest within the V-shape.

The V-shaped first edge 1315 is comprised of a first section 1310c and a second section 1310d that meet at an apex 1338. Apex 1338 is equidistant from a first end 1357 of first section 1310c and a second end 1359 of second section 1310d. As discussed previously, first edge 1315 may have any shape, though preferably is formed having a shape which is complementary to at least a portion of the peak region around peak 1320 of the roof truss. Therefore, first edge 1315 may be formed without a V-shaped apex 1338, as shown in gusset 1310′ of FIG. 53A as flat top 1338′. First edge 1315 of gusset 1310′ is complementarily shaped to the region around peak 1320, but does not extend to peak 1320 itself.

First and second sections 1310c, 1310d are disposed at an angle relative to each other and that angle is such that first edge 1315 is more or less complementary to the outermost surfaces 1312a, 1314a of the truss members 1312, 1314 which plate 1310 is configured to secure together. A longitudinal axis “Y” extends through apex 1338 and generally along a midline of the plate 1310 and the plate 1310 is substantially symmetrical about that midline.

In accordance with a specific feature of the invention, U-shaped second edge 1317 is comprised of a first leg 1360, a second leg 1362 and a third leg 1364. First leg 1360 has a first end 1361 and a second end 1363. Third leg 1360 has a first end 1365 and a second end 1367. Second leg 1362 extends between second end 1363 of first leg 1360 and first end 1365 of third leg 1364. Second leg 1362 is disposed substantially at right angles to the longitudinal axis “Y” of plate 1310 and apex 1338 of first edge 1315 is generally aligned with a midpoint 1369 of second leg 1362. First and second legs 1360, 1362 meet at a first obtuse angle to form a first corner region 1370a. Second and third legs 1362, 1364 meet at a second obtuse angle to form a second corner region 1370b. Preferably, the first and second obtuse angles are substantially equal in size and are between 135 and 175 degrees, as shown in FIG. 53 as Θ.

The outer perimeter of plate member 1310 further includes a first side edge 1310f and a second side edge 1310g. First side edge 1310f extends between first end 1357 of first section 1310c and first end 1361 of first leg 1360. Second side edge 1310g extends between second end 1359 of second section 1310d and second end 1367 of third leg 1364.

Gusset plate 1310 includes an attachment region 1328 and an anchor portion 1330. Attachment region includes a plurality of gripping teeth 1311 (FIG. 54) that project outwardly for a distance from rear surface 1310b of plate 1310 and generally at right angles thereto. The number 1336 in FIGS. 53 and 54 indicates the regions on front surface 1310a that correspond to the regions on the rear surface 1310b where teeth 1311 are located. Teeth 1311 are substantially identical to the teeth 13 of the first embodiment of the gusset plate 10 and are shaped so as to be able to be pressed into the wood of truss members 1312, 1314.

Anchor portion 1330 is disposed adjacent the second edge 1317 and extends for a distance inwardly therefrom and toward the first edge 1315. Anchor portion 1330 is integral with attachment region 1328 and preferably is coplanar therewith. Though not shown in FIGS. 53 and 54, anchor portion 1330 may be reinforced by increasing the thickness thereof relative to the rest of gusset plate 1310. Anchor portion 1330 preferably also includes teeth 1311 extending outwardly from the rear surface 1310b thereof. Anchor portion 1330 is provided to engage a shackle 1349 of an anchoring system as will be hereinafter described.

In accordance with another specific feature of the present invention, gusset plate 1310 includes a first wing 1366 and a second wing 1368 that extend outwardly for a distance beyond second leg 1362 of second edge 1317 and in generally opposing directions relative to each other. First wing 1366 is comprised of a portion of attachment region 1328 and a portion of anchor portion 1330 and is bounded by first leg 1360, first side edge 1310f and a length of first section 1310c. Second wing 1368 is comprised of a portion of attachment region 1328 and a portion of anchor portion 1330 and is bounded by third leg 1365, second side edge 1310h and a length of second section 1310d. As shown in FIG. 53, first and second wings 1366, 1368 are complementary in shape and angle to those sections of the truss members 1312, 1314 to which gusset plate 1310 is to be attached. As shown in FIG. 53A, first and second wings 1366 and 1368 may alternatively be shaped to include an extended portion, shown in phantom, tapering in a parallel direction to longitudinal axis Y. These extended portions provide further reinforcement of truss members 1312 and 1314. Each of first and second wings 1366, 1368 include a plurality of teeth 1311 that extend outwardly away from rear surface 1310b thereof and at right angles thereto.

Gusset plate 1310 is used to connect truss members 1312 and 1314 together. Preferably, and as shown in FIG. 53, gusset plate 1310 may also be at least partially attached to an upper end 1313a of a king post 1313 that forms part of the truss. Truss members 1312, 1314 are configured to abut each other and form a peak 1320. An adhesive may be applied between the abutting faces of the truss members 1312, 1313, 1314 prior to positioning of the gusset plate 1310. As shown in FIG. 53, apex 1338 of gusset plate 1310 is positioned adjacent the peak 1320, the first section 1310c is positioned to substantially align with the outer surface 1312a of truss member 1312, and second section 1310d is positioned to substantially align with the outer surface 1314a of truss member 1314. As an alternative to a peaked apex 1338, gusset 1310′ (FIG. 53A) may be formed having flat top 1338′. Thus, first edge 1315 of gusset 1310′ reinforces the portion of the roof truss region around truss peak 1320, while not reinforcing peak 1320 itself, whereas first edge 1315 of gusset 1310 reinforces the region around peak 1320 as well as peak 1320 itself. As adhesives and first and second wings 1366 and 1368 of gusset 1310′ hold truss members 1312 and 1314 together, gusset 1310′ need not extend entirely to peak 1320, as shown in FIG. 53A.

Teeth 1311 are placed in abutting contact with side surfaces 1312b, 1314b of truss members 1312 and 1314, and the side surface of king post 1313, if present. A hammer or other suitable tool is struck against front surface 1310a of plate 1310 to drive teeth 1311 into the wood of truss members 1312, 1313 and 1314. (Obviously, if truss member 1313 is not to be secured to truss members 1312, 1314, the teeth in that related region of plate 1310 will not contact and be driven into any wood). Attachment region 1328 preferably does not extend vertically above and laterally outwardly beyond peak 1320 or upper surfaces 1312a, 1314a of first and second truss members 1312, 1314 when secured thereto. When gusset plate 1310 is positioned on first and second truss members 1312, 1314, the anchor portion 1330 preferably is oriented laterally relative to peak 1320 and is disposed vertically downward therefrom.

FIG. 53 illustrates that when gusset plate 1310 is secured to truss members 1312, 1314, second leg 1362 is disposed a distance vertically beneath the lowermost connection point 1313a of truss members 1312, 1313 and 1314. First and second wings 1366, 1368 extend for a distance further downwardly along truss members 1312, 1314 and beyond second leg 1362. The teeth 1311 on first and second wings 1366, 1368 ensure that gusset plate 1310 is able to be firmly attached to truss members 1312, 1314 in the areas above, below and alongside corner regions 1370a and 1370b. This ensures that when force is applied to the truss and to gusset plate 1310 by an anchor safety system, as will be hereinafter described, gusset plate 1310 will not become loosened or be pulled free of truss members 1312, 1314. First and second wings 1366, 1368 thereby aid in ensuring that gusset plate 1310 presents a strong, rigid surface for anchoring a security line 1318 of the safety system.

Gusset plate 1310 is designed to be permanently secured to the roof truss at a manufacturing facility and is not meant to be removed therefrom. The roof truss so formed is generally triangular in shape and is comprised of first roof truss member 1312, second roof truss member 1314 and a horizontal cross-beam (not illustrated in FIGS. 51-53 but shown in FIG. 3). First and second truss members 1312, 1314 and the cross-beam define and bound a cavity (not numbered) between them. When king post 1313 is present, it extends between the cross-beam and the first and second roof truss members 1312, 1314 and a first cavity is bounded by first roof truss member 1312, king post 1313 and a first portion of the cross-beam and a second cavity is bounded by second roof truss member 1314, king post 1313 and a second portion of the cross-beam. When gusset plate 1310 is secured to first and second roof truss members 1312, 1314, at least a portion of the U-shaped edge of gusset plate 1310 bounds the cavity in the roof truss.

After the truss system is adequately braced, the roof truss and gusset plate 1310 may be used to secure a safety anchor system for a roofer while he installs components of the roof, such as the first sheet member 1324. The safety anchor system includes security line 1318, a carabiner 1348 and a “D-shaped” shackle 1349 that is substantially identical to the shackle 1249 illustrated in FIG. 52. Shackle 1349 has a body that includes a pin 1351, a crossbar 1353 and an upper end 1355 remote from pin 1351 and side members (unnumbered) that connect pin 1351, crossbar 1353 and upper end 1355 together. Pin 1351, crossbar 1353, and portions of the side members connecting them together bound and define a cavity (unnumbered) in shackle 1349.

When a roofer is ready to install the roof, he attaches shackle 1349 to a first end of security line 1318. Although not illustrated herein, the roofer also attaches a second connector at a second end of the security line 1318 to a harness that he is wearing. He then engages shackle 1349 with the roof truss and gusset plate 1310 in the manner illustrated in FIG. 53. Shackle 1349 is engaged so that pin 1351 extends through the cavity in the roof truss and is positioned adjacent the interior second edge 1317 of plate 1310 and adjacent a portion of the interior surfaces 1312d, 1314d of one of first and second roof truss members 1312, 1314. The crossbar 1353 is positioned outside of the cavity and adjacent the exterior surfaces 1310c, 1310d of gusset plate 1310 and the exterior surfaces 1312a, 1314a of one of first and second roof truss members 1312, 1314. Furthermore, one of the first and second roof truss members 1312, 1314 extends through the cavity in the shackle 1349. Shackle 1349 is able to slide along portions of the first and second roof truss members 1312, 1314 and along portions of the U-shaped edge of gusset plate 1310. When king post 1313 forms part of the roof truss, shackle 1349 may slide into contact with the sides of king post 1313 as well.

Crossbar 1353 preferably is positioned a distance below peak 1320, and the rest of the body of shackle 1349 is disposed adjacent and substantially parallel to front face 1310a of plate 1310 and adjacent the rear surface of the truss. This arrangement enables crossbar 1353 of shackle 1349 to securely contact the wood of the truss which is reinforced by first edge 1315 of gusset plate 1310, while positioning top end 1355 of shackle 1349 at a height suitable to permit carabiner 1348 and security line 1318 to cross the peak 1320. Carabiner 1348 is secured to shackle 1349 between crossbar 1353 and upper end 1355. When force is applied to the security line 1318, indicated by the arrow adjacent thereto, the angle of shackle 1349 changes causing pin 1351 to slide along second edge 1317 and toward corner region 1370a. Pin 1351 may come to rest in corner region 1370a. Thus the plate 1310 minimizes damage that might be caused to the truss members 1312, 1314 by the force applied to the anchor safety system. It will be understood that during use of the anchor safety system, pin 1351 may be caused to contact regions of second edge 1317 other than corner region 1370a. First and second wings 1370, 1372 aid in preventing the wood of truss members 1312, 1314 from splitting when anchor system is used, and the wings, together with the rest of gusset plate 1310, contribute to the overall integrity and strength of the truss.

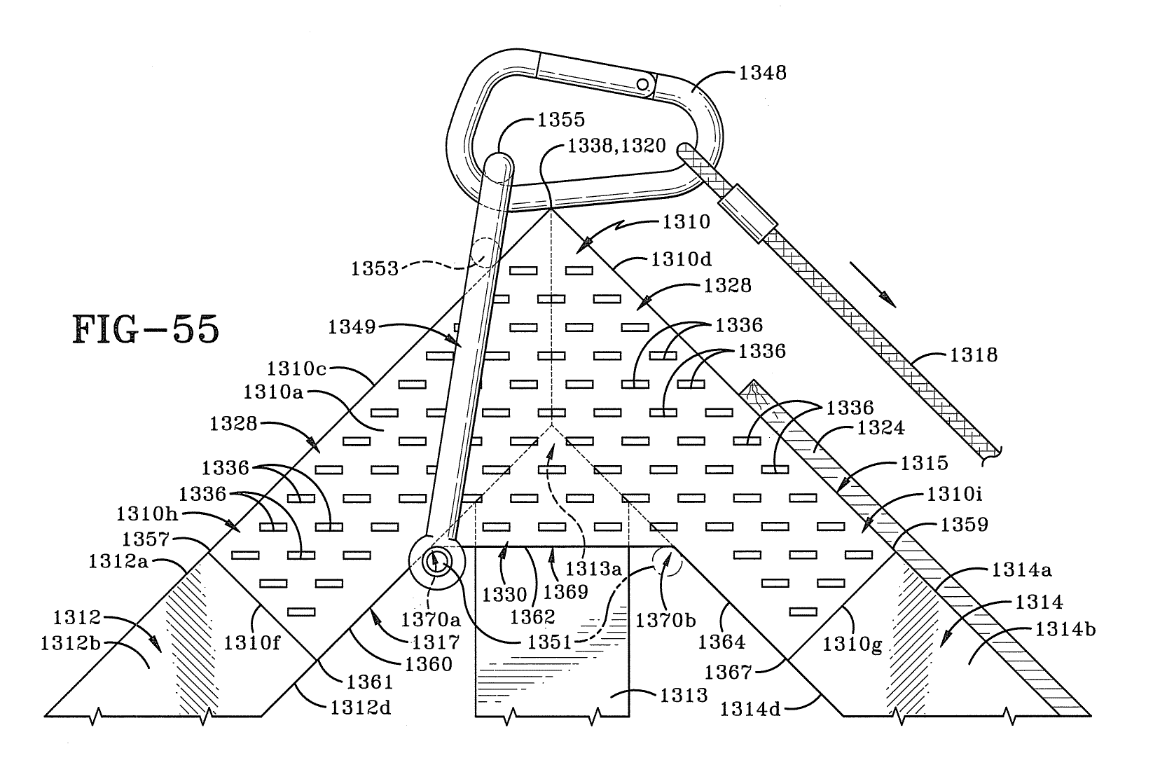

In the instance illustrated in FIG. 55 the pin 1351 is disposed the opposite side of the roof from the roofer and, consequently, the lines of force are directed through the wood of peak 1320, through the wood of king post 1313 and through the metal of gusset plate 1310. Thus, the truss, the king post 1313 and gusset plate 1310 aid in acting as a support for the roofer. The roofer can therefore install sheet member 1324 and shingles (not shown) in relative safety. As the roofer moves to the next section of the roof, he will detach shackle 1349 and carabiner 1348 from around gusset plate 1310 and reattach the same to another similar gusset plate and truss.

If security line 1318 is positioned to extend down the opposite side of the roof from that illustrated in FIG. 55, pin 1351 will tend to slide outwardly toward corner region 1370b of gusset plate 1310. This is illustrated in FIG. 55 by showing the pin in phantom at that location.

As illustrated in FIG. 53A, it will be understood that gusset plate 1310 may also be provided with flaps that extend outwardly from one or more of first and second sections 1310c, 1310d and which are designed to extend over a portion of the outermost surfaces 1312a, 1314a of truss members 1312, 1314. These flaps would be similar in nature and function to those shown in FIG. 37. Gusset plate 1310 may further be provided with one or more flaps that extend outwardly from the second edge 1317 and in a direction that will cause them to be disposed beneath the lower surfaces of truss members 1312, 1314. These one or more flaps would, again, provide additional strength to that region of the plate and therefore additional protection to the truss.

It is of primary importance for gusset plate 1310 to prevent the splintering of the wood comprising the region around peak 1320. As shown in FIGS. 53 and 53A, portions of first edge 1315 of gusset plate 1310 or 1310′ generally align with outer surfaces 1312a and 1314a of truss members 1312 and 1314, respectively, to provide reinforcement thereto. Gusset plate 1310 and 1310′ reinforces truss members 1312 and 1314 against the forces and stress transferred thereto by shackle 1349 holding the roofer on the roof through carabiner 1348 and security line 1318. It is of secondary importance for gusset plate 1310 and 1310′ to offer an edge to rest crossbar 1353, as first edge 1315 of gusset plate 1310 and 1310′ may not extend entirely to surfaces 1312a and 1314a of truss members 1312 and 1314, respectively, or peak 1320.

Furthermore, although not illustrated in these figures, it will be understood that a substantially identical gusset plate could be similarly applied to the back surfaces of the truss members 1312, 1313, 1314 so that the wood is sandwiched between the two metal plates.

Although the present invention has been described above in detail, the same is by way of illustration and example only and is not to be taken as a limitation on the present invention. It is understood that many variations of the illustrated invention are possible without departing from the scope of the present invention. Accordingly, the scope and content of the present invention are to be defined only by the terms of the appended claims.

1. A roof ridge gusset plate for securing a first roof truss member to a second roof truss member to form a peak of a roof truss, said gusset plate comprising:
a plate member having a front surface and a rear surface and an outer perimeter; and wherein the outer perimeter includes:
a first edge; and
a generally U-shaped second edge disposed opposite the first edge.

2. The gusset plate as defined in claim 1, wherein the plate member further comprises a first wing and a second wing defined between the first edge and the U-shaped second edge.

3. The gusset plate as defined in claim 2, wherein the outer perimeter further comprises:
a first side edge connecting a first end of the first edge to a first end of the U-shaped second edge; and
a second side edge connecting a second end of the first edge to a second end of the U-shaped second edge.

4. The gusset plate as defined in claim 3, wherein the first edge comprises:
a first section and a second section that meet at a apex and are disposed at an angle relative to each other forming a V-shape, and wherein the first end of the V-shaped first edge is a free end of the first section and the second end of the V-shaped first edge is a free end of the second section; and
wherein the V-shape of the first edge and the U-shape of the second edge open in the same direction.

5. The gusset plate as defined in claim 4, wherein the U-shaped second edge comprises:
a first leg having a first end and a second end, where the first end of the first leg constitutes the first end of the U-shaped edge;
a second leg; and
a third leg having a first end and a second end, where the second end of the third leg constitutes the second end of the U-shaped edge; and wherein the second leg extends between the second end of the first leg and the first end of the third leg.

6. The gusset plate as defined in claim 5, wherein the first wing is bounded by the first leg of the U-shaped second edge, the first side edge and a length of the first section of the V-shaped first edge.

7. The gusset plate as defined in claim 6, wherein the second wing is bounded by the third leg of the U-shaped second edge, the second side edge and a length of the second section of the V-shaped first edge.

8. The gusset plate as defined in claim 7, wherein the first wing and the second wing extend outwardly beyond the second leg of the U-shaped second edge.

9. The gusset plate as defined in claim 5, wherein the first and the second legs are disposed at a first obtuse angle relative to each other, and the second and the third legs are disposed at a second obtuse angle relative to each other.

10. The gusset plate as defined in claim 9, wherein the first and the second obtuse angles are substantially equal in size.

11. The gusset plate as defined in claim 10, wherein the first and second obtuse angles are between 135 and 175 degrees.

12. The gusset plate as defined in claim 5, wherein the apex of the V-shaped first edge is aligned with a midpoint of the second leg of the U-shaped second edge.

13. The gusset plate as defined in claim 1, further comprising a plurality of fasteners that extend outwardly from the rear surface of the plate member and are adapted to engage a front surface of each of the first and second truss members.

14. A roof truss comprising:
a first roof truss member having an outer surface, an inner surface and opposing front and back surfaces extending there between, and further including a first end;
a second roof truss member having an outer surface, an inner surface and opposing front and back surfaces extending there between; and further including a second end; wherein the first end and the second end of the first and second roof truss members are complementary shaped to abut each other such that the first and second roof truss members form a V-shaped peak and the front surface of the first roof truss is aligned with the front surface of the second roof truss;
a gusset plate comprising:
a plate member having a front surface and a rear surface and an outer perimeter which includes:
a generally V-shaped first edge;
a generally U-shaped second edge disposed opposite the V-shaped first edge, and wherein the V-shape of the first edge and the U-shape of the second edge open in the same direction; and
a plurality of fasteners extending outwardly from the rear surface of the plate member and into the aligned front surfaces of the first and second roof truss members adjacent the peak.

15. The roof truss as defined in claim 14, wherein the plate member further comprises a first wing and a second wing defined between the V-shaped first edge and the U-shaped second edge, and the first wing extends for a distance along the front surface of the first roof truss member and the second wing extends for a distance along the front surface of the second roof truss member.

16. The roof truss as defined in claim 15, wherein the V-shaped first edge comprises:
a first section and a second section that meet at a apex and are disposed at an angle relative to each other, wherein the apex is generally aligned with and adjacent to the peak of the first and second truss members when the gusset plate is secured thereto, and the first section is generally aligned with and adjacent to the outer surface of the first roof truss member, and the second section is generally aligned with and adjacent to the outer surface of the second roof truss member.

17. The roof truss as defined in claim 16, wherein the U-shaped second edge comprises:
a first leg having a first end and a second end and being substantially aligned with the inner surface of the first truss member;
a second leg; and
a third leg having a first end and a second end and being substantially aligned with the inner surface of the second truss member; and wherein the second leg extends between the second end of the first leg and the first end of the third leg, and the second leg is spaced a distance downwardly away from a region where the inner surfaces of the first and second truss members meet.

18. The roof truss as defined in claim 17, wherein the first wing extends for a distance along the front surface of the first roof truss member for a distance outwardly beyond the second leg of the U-shaped second edge; and the second wing extends for a distance along the front surface of the second roof truss member for a distance outwardly beyond the second leg of the U-shaped second edge.

19. An anchoring system for a roofer comprising:
a) a roof truss including:
a first roof truss member; and a second roof truss member; wherein an end of the first roof truss member abuts an end of the second roof truss member to form a V-shaped peak and a front surface of the first roof truss member is aligned with a front surface of the second roof truss member;
b) a gusset plate comprised of:
a plate member having a front surface and a rear surface;
a plurality of fasteners extending outwardly from the rear surface of the plate member and into the aligned front surfaces of the first and second roof truss members;
c) a security line comprised of:
a length of cord having a first end and a second end;
a first connector engaged with the first end of the cord, a first cavity defined in the first connector; wherein one of the first and second roof truss members extends through the first cavity when the first connector is detachably engaged with the roof truss and gusset plate; and
a second connector engaged with the second end of the cord and being adapted to engage a harness worn by the roofer.

20. The anchoring system as defined in claim 19, wherein a second cavity is defined in the roof truss, said second cavity being at least partially defined and bounded by the first and second roof truss members; and wherein the first connector includes a first member and a second member, and the first member extends through the second cavity when the first connector is detachably engaged with the roof truss and the gusset plate.

21. The anchoring system as defined in claim 20, wherein the plate member of the gusset plate includes an outer perimeter and the outer perimeter includes:
a generally V-shaped first edge; and
a generally U-shaped second edge disposed opposite the V-shaped first edge, wherein the V-shape of the first edge and the U-shape of the second edge open in the same direction.

22. The anchoring system as defined in claim 21, wherein the U-shaped second edge of the gusset plate bounds and defines a portion of the second cavity; and the first connector is able to slide along the one of the first and second roof truss members and along the U-shaped second edge of the plate member.

23. The anchoring system as defined in claim 21, wherein the plate member further includes a first wing and a second wing defined between the V-shaped first edge and the U-shaped second edge, where the first wing extends for a distance along the front surface of the first roof truss member and the second wing extends for a distance along the front surface of the second roof truss member.

24. The anchoring system as defined in claim 20, wherein the first connector is a D-shaped shackle comprising:
a first pin;
a crossbar disposed a spaced distance away from the first pin;
an upper end disposed a spaced distance away from the crossbar;
a pair of opposed sides that extend between and connect the first pin, the crossbar and the upper end together.

25. The anchoring system for a roofer as defined in claim 24, wherein the first pin is the first member of the first connector and the crossbar is the second member of the first connector and one of the first and second roof truss members extends through the first cavity defined between the first pin and the crossbar.

26. The anchoring system as defined in claim 25, wherein the first pin extends through the second cavity in the roof truss and the first pin abuts the U-shaped second edge of the plate member; and the crossbar abuts one of the first roof truss member, the second roof truss member, and first edge of the plate member.
